(19) United States
(12) Patent Application Publication
(10) Pub. No.: US 2014/0056535 A1
(43) Pub. Date: Feb. 27, 2014

(54) IMAGE PROCESSING DEVICE AND METHOD

(71) Applicant: Sekie Suzuki, Tokyo (JP)

(72) Inventor: Sekie Suzuki, Tokyo (JP)

(73) Assignee: Sony Corporation, Tokyo (JP)

(21) Appl. No.: 14/114,259

(22) PCT Filed: May 11, 2012
(86) PCT No.: PCT/JP2012/062088

§ 371 Date: Oct. 28, 2013

(30) Foreign Application Priority Data
May 19, 2011 (JP) 2011-112314

(51) Int. Cl. G06T 9/00

(52) U.S. Cl. CPC G06T 9/007
USPC 382/248

(57) ABSTRACT

The present technique relates to image processing devices and methods that realize reductions of memory usage in orthogonal transform operations and inverse orthogonal transform operations. This disclosure includes: a horizontal one-dimensional inverse transform unit that performs a horizontal inverse orthogonal transform on an orthogonal transform coefficient generated by performing an orthogonal transform on image data in a horizontal direction and a vertical direction; a bit width processing unit that performs a clip operation on a coefficient to reduce a bit width, the coefficient being obtained by the horizontal one-dimensional inverse transform unit performing the horizontal inverse orthogonal transform; a storage unit that stores the coefficient as intermediate data, the coefficient having the bit width reduced by the bit width processing unit performing the clip operation; and a vertical one-dimensional inverse transform unit that reads the intermediate data from the storage unit one line at a time in the vertical direction, and performs a vertical inverse orthogonal transform. This disclosure can be applied to image processing devices.

### TECHNICAL FIELD

This disclosure relates to image processing devices and methods, and more particularly, to an image processing device and method, and a program that realize reductions of memory usage in orthogonal transform operations and inverse orthogonal transform operations.

### BACKGROUND ART

In recent years, to handle image information as digital information and achieve high-efficiency information transmission and accumulation in doing do, apparatuses compliant with a standard, such as MPEG (Moving Picture Experts Group) for compressing image information through orthogonal transforms such as discrete cosine transforms and motion compensation by taking advantage of redundancy inherent to the image information, have been spreading among broadcast stations to distribute information and among general households to receive information.

Particularly, MPEG2 (ISO (International Organization for Standardization)/IEC (International Electrotechnical Commission) 13818-2) is defined as a general-purpose image encoding standard, and is applicable to interlaced images and non-interlaced images, and to standard-resolution images and high-definition images. Currently, MPEG2 is used in a wide range of applications for professionals and general consumers. According to the MPEG2 compression method, a bit rate of 4 to 8 Mbps is assigned to an interlaced image having a standard resolution of 720×480 pixels, and a bit rate of 18 to 22 Mbps is assigned to an interlaced image having a high-resolution of 1920×1088 pixels, for example. In this manner, high compression rates and excellent image quality can be realized.

MPEG2 is designed mainly for high-quality image encoding suited for broadcasting, but is not compatible with lower bit rates than MPEG1 or encoding methods involving higher compression rates. As mobile terminals are becoming popular, the demand for such encoding methods is expected to increase in the future, and to meet the demand, the MPEG4 encoding method was standardized. As for an image encoding method, the ISO/IEC 14496-2 standard was approved as an international standard in December 1998.

Further, a standard called H.26L (ITU-T (International Telecommunication Union Telecommunication Standardization Sector) Q6/16 VCEG (Video Coding Expert Group)), which is originally intended for encoding images for video conferences, is currently being set. Compared with the conventional encoding methods such as MPEG2 and MPEG4, H.26L requires a larger amount of calculation in encoding and decoding, but is known to achieve a higher encoding efficiency. Also, as a part of the MPEG4 activity, “Joint Model of Enhanced-Compression Video Coding” is now being established as a standard for achieving a higher encoding efficiency by incorporating functions unsupported by H.26L into the functions based on H.26L.

On the standardization schedule, the standard was approved as an international standard under the name of H.264 and MPEG-4 Part 10 (Advanced Video Coding, hereinafter referred to as AVC) in March 2003.

However, the macroblock size of 16×16 pixels might not be optimal for a large frame such as an UHD (Ultra High Definition: 4000×2000 pixels) frame to be encoded by a next-generation encoding method.

In view of this and for the purpose of achieving an even higher encoding efficiency than that achieved by AVC, an encoding method called HEVC (High Efficiency Video Coding) is now being standardized by JCTVC (Joint Collaboration Team—Video Coding), which is a joint standards organization of ITU-T and ISO/IEC (see Non-Patent Document 1, for example).

According to the HEVC encoding method, coding units (CUs) are defined as processing units like macroblocks of AVC. Unlike the macroblocks of AVC, the CUs are not fixed to the size of 16×16 pixels. The size of the CUs is specified in the compressed image information in each sequence.

According to those encoding methods, orthogonal transforms and inverse orthogonal transforms are performed on image data. Both orthogonal transforms and inverse orthogonal transforms are performed in the horizontal direction and the vertical direction (two dimensions). In an orthogonal transform, for example, a one-dimensional orthogonal transform is first performed in the horizontal direction, the resultant (referred to as the intermediate data) is transposed by using a transposition register, and a one-dimensional orthogonal transform is then performed in the vertical direction. The same applies to inverse orthogonal transforms. That is, in those operations, storage areas (transposition registers) are required for temporarily saving the intermediate data.

While the processing unit size for orthogonal transforms and inverse orthogonal transforms according to AVC or the like is 8×8 pixels, the processing unit size for orthogonal transforms and inverse orthogonal transforms according to HEVC is expanded to 16×16 pixels, 32×32 pixels, or 64×64 pixels, for example.

However, when the processing unit size for orthogonal transforms and inverse orthogonal transforms becomes as large as the above, there is a possibility that the capacity of the transposition register (storage area) for saving the intermediate data also increases by a large amount.

According to Non-Patent Document 1, the required transposition register size is (21×256) bits=5,376 bits in the case of a block of 16×16 pixels, and is (25×1024) bits=25,600 bits in the case of a block of 32×32 pixels. Those are 5.25 and 25 times larger than that in the case of a block of 8×8 pixels in AVC.

In view of this, there is a suggestion that a uniform bit width of 16 bits should be set for the intermediate data (see Non-Patent Document 2 and Non-Patent Document 3, for example). By this method, the required transposition register size is (16×256) bits=4,096 bits in the case of a block of 16×16 pixels, and is (16×1024) bits=16,384 bits in the case of a block of 32×32 pixels. In this case, the required storage area is four and 16 times larger than that in the case of a block of 8×8 pixels of AVC.

There are various methods for performing orthogonal transforms and inverse orthogonal transforms, such as discrete cosine transforms (DCTs), discrete sine transforms (DSTs), and Karhunen-Loeve transforms. Also, there are suggested methods for performing orthogonal transforms and inverse orthogonal transforms in different manners in the horizontal direction and the vertical direction, as in DCTs and DSTs, for example (see Non-Patent Document 4, for example).

### CITATION LIST

### Non-Patent Documents

Non-Patent Document 1: Thomas Wiegand, Woo-Jin Han, Benjamin Bross, Jens-Rainer Ohm, Gary J. Sullivan, “Working Draft 1 of High-Efficiency Video Coding”, JCTVC-C403, Joint Collaborative Team on Video Coding (JCT-VC) of ITU-T SG16 WP3 and ISO/IEC JTC1/SC29/WG113rd Meeting: Guangzhou, CN, 7-15 Oct., 2010
Non-Patent Document 2: A. Fuldseth, G. Bjoentegaard, “Unified transform design for HEVC with 16 bit intermediate data representation”, JCTVC-D224, Joint Collaborative Team on Video Coding (JCT-VC) of ITU-T SG16 WP3 and ISO/IEC JTC1/SC29/WG114th Meeting: Daegu, KR, 20-28 Jan., 2011
Non-Patent Document 3: Kiran Misra, Louis Kerofsky, Andrew Segall, “On transform dynamic range”, JCTVC-D071, Joint Collaborative Team on Video Coding (JCT-VC) of ITU-T SG16 WP3 and ISO/IEC JTC1/SC29/WG114th Meeting: Daegu, KR, 20-28 Jan., 2011
Non-Patent Document 4: Ankur Saxena, Felix C. Fernandes, “CE7:Mode-dependent DCT/DST without 4*4 full matrix multiplication for intra prediction”, JCTVC-E125, Joint Collaborative Team on Video Coding (JCT-VC) of ITU-T SG16 WP3 and ISO/IEC JTC1/SC29/WG115th Meeting: Geneva, CH, 16-23 Mar., 2011

### SUMMARY OF THE INVENTION

### Problems to be Solved by the Invention

However, there is a demand for preventing further increases of transposition registers.

This disclosure is made in view of those circumstances, and is to prevent increases of memory usage due to an increased processing unit in orthogonal transform operations and inverse orthogonal transform operations.

### Solutions to Problems

One aspect of this disclosure is an image processing device that includes: a horizontal one-dimensional inverse transform unit that performs a horizontal inverse orthogonal transform on an orthogonal transform coefficient generated by performing an orthogonal transform on image data in a horizontal direction and a vertical direction; a bit width processing unit that performs a clip operation on a coefficient to reduce a bit width, the coefficient being obtained by the horizontal one-dimensional inverse transform unit performing the horizontal inverse orthogonal transform; a storage unit that stores the coefficient as intermediate data, the coefficient having the bit width reduced by the bit width processing unit performing the clip operation; and a vertical one-dimensional inverse transform unit that reads the intermediate data from the storage unit one line at a time in the vertical direction, and performs a vertical inverse orthogonal transform.

The bit width processing unit may perform the clip operation to adjust the coefficient to a bit width in accordance with the frequency band of the coefficient.

The image processing device may further include: a subtraction unit that subtracts coefficients of the same frequency band from each other, the coefficients being obtained by the horizontal one-dimensional inverse transform unit performing the horizontal inverse orthogonal transform; and an addition unit that adds the difference value obtained through the subtraction performed by the subtraction unit to one of the coefficients used in the subtraction. The bit width processing unit may perform the clip operation on the difference value obtained through the subtraction, to reduce the bit width of the difference value. The storage unit may store the intermediate data formed with the one of the coefficients used in the subtraction and the difference value having the bit width reduced by the bit width processing unit. The addition unit may restore the other one of the coefficients used in the subtraction by adding the one of the coefficients used in the subtraction to the difference value having the bit width reduced, the one of the coefficients and the difference value being read from the storage unit. The vertical one-dimensional inverse transform unit may perform the vertical inverse orthogonal transform on the one of the coefficients used in the subtraction, and the other one of the coefficients used in the subtraction and restored through the addition performed by the addition unit.

The addition unit may read the intermediate data from the storage unit one line at a time in the vertical direction, and the storage unit may store the one of the coefficients used in the subtraction in the line to be read by the addition unit at last.

The bit width processing unit may perform the clip operation to adjust the difference value to a predetermined bit width.

The bit width processing unit may perform the clip operation to adjust the difference value to a bit width in accordance with the frequency band of the difference value.

The image processing device may further include a mean value calculation unit that calculates the mean value of coefficients of the same frequency band, the coefficients being obtained by the horizontal one-dimensional inverse transform unit performing the horizontal inverse orthogonal transform. The subtraction unit may calculate a difference value between a coefficient obtained by the horizontal one-dimensional inverse transform unit performing the horizontal inverse orthogonal transform and the mean value calculated by the mean value calculation unit. The bit width processing unit may perform the clip operation on the difference value calculated by the subtraction unit, to reduce the bit width of the difference value. The storage unit may store the intermediate data formed with the mean value and the difference value having the bit value reduced by the bit width processing unit. The addition unit may restore the coefficient used in the subtraction by adding the difference value to the mean value, the difference value and the mean value being read from the storage unit. The vertical one-dimensional inverse transform unit may perform the vertical inverse orthogonal transform on the coefficient used in the subtraction.

The bit width processing unit may perform the clip operation to adjust the difference value to a predetermined bit width.

The bit width processing unit may perform the clip operation to adjust the difference value to a bit width in accordance with the frequency band of the difference value.

The horizontal one-dimensional inverse transform unit and the vertical one-dimensional inverse transform unit may perform inverse orthogonal transforms by different transform methods from each other.

The one aspect of this disclosure is also an image processing method for an image processing device. This image processing method includes: a horizontal one-dimensional inverse transform unit performing a horizontal inverse orthogonal transform on an orthogonal transform coefficient generated by performing an orthogonal transform on image data in a horizontal direction and a vertical direction; a bit width processing unit performing a clip operation on a coefficient to reduce a bit width, the coefficient being obtained through the horizontal inverse orthogonal transform; a storage unit storing the coefficient as intermediate data, the coefficient having the bit width reduced through the clip operation; and a vertical one-dimensional inverse transform unit reading the intermediate data from the storage unit one line at a time in the vertical direction, and performing a vertical inverse orthogonal transform.

Another aspect of this disclosure is an image processing device that includes: a horizontal one-dimensional transform unit that performs a horizontal orthogonal transform on image data; a bit width processing unit that performs a clip operation on a coefficient to reduce a bit width, the coefficient being obtained by the horizontal one-dimensional transform unit performing the horizontal orthogonal transform; a storage unit that stores the coefficient as intermediate data, the coefficient having the bit width reduced by the bit width processing unit performing the clip operation; and a vertical one-dimensional transform unit that reads the intermediate data from the storage unit one line at a time in the vertical direction, and performs a vertical orthogonal transform.

The bit width processing unit may perform the clip operation to adjust the coefficient to a bit width in accordance with the frequency band of the coefficient.

The image processing device may further include: a subtraction unit that subtracts coefficients of the same frequency band from each other, the coefficients being obtained by the horizontal one-dimensional transform unit performing the horizontal orthogonal transform; and

an addition unit that adds the difference value obtained through the subtraction performed by the subtraction unit to one of the coefficients used in the subtraction. The bit width processing unit may perform the clip operation on the difference value obtained through the subtraction, to reduce the bit width of the difference value. The storage unit may store the intermediate data formed with the one of the coefficients used in the subtraction and the difference value having the bit width reduced by the bit width processing unit. The addition unit may restore the other one of the coefficients used in the subtraction by adding the one of the coefficients used in the subtraction to the difference value having the bit width reduced, the one of the coefficients and the difference value being read from the storage unit. The vertical one-dimensional transform unit may perform the vertical orthogonal transform on the one of the coefficients used in the subtraction, and the other one of the coefficients used in the subtraction and restored through the addition performed by the addition unit.

The bit width processing unit may perform the clip operation to adjust the difference value to a predetermined bit width.

The bit width processing unit may perform the clip operation to adjust the difference value to a bit width in accordance with the frequency band of the difference value.

The horizontal one-dimensional transform unit and the vertical one-dimensional transform unit may perform orthogonal transforms by different transform methods from each other.

Another aspect of this disclosure is also an image processing method for an image processing device. This image processing method includes: a horizontal one-dimensional transform unit performing a horizontal orthogonal transform on image data; a bit width processing unit performing a clip operation on a coefficient to reduce a bit width, the coefficient being obtained through the horizontal orthogonal transform; a storage unit storing the coefficient as intermediate data, the coefficient having the bit width reduced through the clip operation; and a vertical one-dimensional transform unit reading the intermediate data from the storage unit one line at a time in the vertical direction, and performing a vertical orthogonal transform.

In one aspect of this disclosure, a horizontal inverse orthogonal transform is performed on an orthogonal transform coefficient generated by performing an orthogonal transform on image data in the horizontal direction and the vertical direction, and a clip operation to reduce a bit width is performed on the coefficient obtained through the horizontal inverse orthogonal transform. The coefficient that has been subjected to the clip operation and has its bit width reduced is stored as intermediate data. The stored intermediate data is read one line at a time in the vertical direction, and a vertical inverse orthogonal transform is performed.

In another aspect of this disclosure, a horizontal orthogonal transform is performed on image data, and a clip operation to reduce a bit width is performed on the coefficient obtained through the horizontal orthogonal transform. The coefficient that has been subjected to the clip operation and has its bit width reduced is stored as intermediate data. The stored intermediate data is read one line at a time in the vertical direction, and a vertical orthogonal transform is performed.

### Effects of the Invention

According to this disclosure, images can be processed. Particularly, increases of memory usage in orthogonal transform operations and inverse orthogonal transform operations can be prevented.

### BRIEF DESCRIPTION OF DRAWINGS

FIG. 1 is a block diagram showing a typical example structure of an image decoding device.

FIG. 2 is a diagram showing example macroblocks.

FIG. 3 is a diagram for explaining example structures of coding units.

FIG. 4 is a block diagram showing a typical example structure of the inverse orthogonal transform unit.

FIG. 5 is a diagram for explaining an example of frequency distribution of intermediate data.

FIG. 6 is a diagram for explaining examples of intermediate data.

FIG. 7 is a flowchart for explaining an example flow in a decoding operation.

FIG. 8 is a flowchart for explaining an example flow in the inverse orthogonal transform operation.

FIG. 9 is a block diagram showing another example structure of the inverse orthogonal transform unit.

FIG. 10 is a diagram for explaining another example of intermediate data.

FIG. 11 is a diagram for explaining yet another example of intermediate data.

FIG. 12 is a flowchart for explaining another example flow in the inverse orthogonal transform operation.

FIG. 13 is a flowchart for explaining yet another example flow in the inverse orthogonal transform operation.

FIG. 14 is a block diagram showing yet another example structure of the inverse orthogonal transform unit.

FIG. 15 is a diagram for explaining yet another example of intermediate data.

FIG. 16 is a flowchart for explaining yet another example flow in the inverse orthogonal transform operation.

FIG. 17 is a flowchart for explaining yet another example flow in the inverse orthogonal transform operation.

FIG. 18 is a block diagram showing a typical example structure of an image encoding device.

FIG. 19 is a block diagram showing a typical example structure of the orthogonal transform unit.

FIG. 20 is a diagram for explaining another example of frequency distribution of intermediate data.

FIG. 21 is a diagram for explaining other examples of intermediate data.

FIG. 22 is a flowchart for explaining an example flow in an encoding operation.

FIG. 23 is a flowchart for explaining an example flow in the orthogonal transform operation.

FIG. 24 is a block diagram showing another example structure of the orthogonal transform unit.

FIG. 25 is a diagram for explaining yet another example of intermediate data.

FIG. 26 is a diagram for explaining still another example of intermediate data.

FIG. 27 is a flowchart for explaining another example flow in the orthogonal transform operation.

FIG. 28 is a flowchart for explaining yet another example flow in the orthogonal transform operation.

FIG. 29 is a block diagram showing a typical example structure of a personal computer.

FIG. 30 is a block diagram schematically showing an example structure of a television apparatus.

FIG. 31 is a block diagram schematically showing an example structure of a portable telephone device.

FIG. 32 is a block diagram schematically showing an example structure of a recording/reproducing apparatus.

FIG. 33 is a block diagram schematically showing an example structure of an imaging apparatus.

### MODES FOR CARRYING OUT THE INVENTION

The following is a description of modes for carrying out the invention (hereinafter referred to as the embodiments). Explanation will be made in the following order.

1. First Embodiment (Image Decoding Device)

2. Second Embodiment (Inverse Orthogonal Transform Unit)

3. Third Embodiment (Inverse Orthogonal Transform Unit)

4. Fourth Embodiment (Image Encoding Device)

5. Fifth Embodiment (Orthogonal Transform Unit)

6. Sixth Embodiment (Personal Computer)

7. Seventh Embodiment (Television Receiver)

8. Eighth Embodiment (Portable Telephone Device)

9. Ninth Embodiment (Recording/Reproducing Apparatus)

10. Tenth Embodiment (Imaging Apparatus)

### 1. First Embodiment

### [Image Decoding Device]

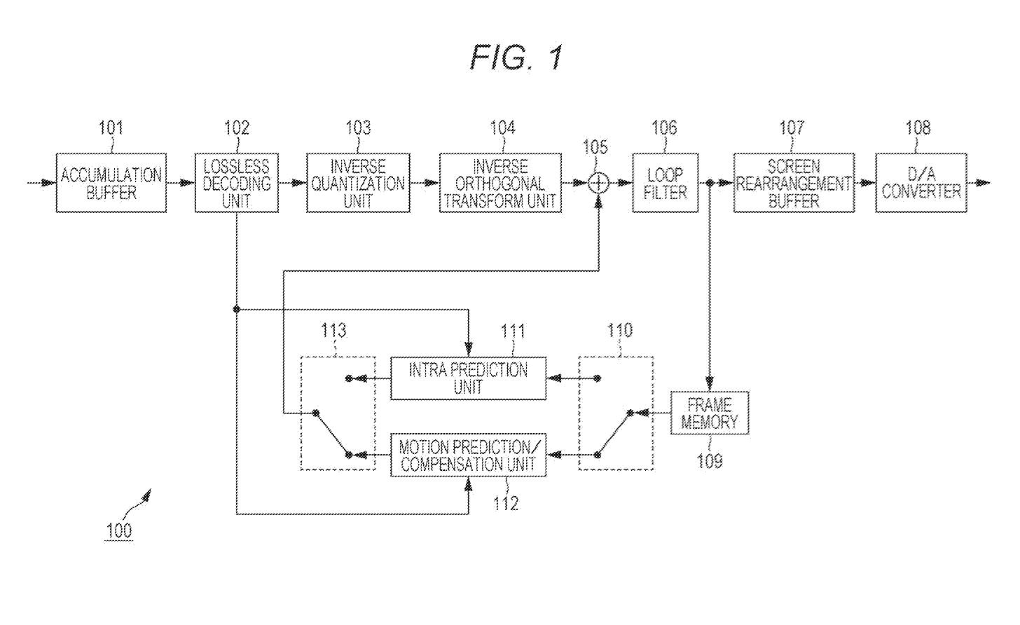

FIG. 1 is a block diagram showing a typical example structure of an image decoding device that is an embodiment of an image processing device.

The image decoding device 100 shown in FIG. 1 is a device that obtains decoded images by acquiring and decoding encoded data generated by encoding image data through prediction operations in an image encoding device using an encoding method such as H.264 and MPEG (Moving Picture Experts Group) 4 Part 10 (AVC (Advanced Video Coding)) or HEVC (High Efficiency Video Coding).

As shown in FIG. 1, the image decoding device 100 includes an accumulation buffer 101, a lossless decoding unit 102, an inverse quantization unit 103, an inverse orthogonal transform unit 104, an arithmetic operation unit 105, a loop filter 106, a screen rearrangement buffer 107, and a D/A converter 108. The image decoding device 100 also includes a frame memory 109, a selection unit 110, an intra prediction unit 111, a motion prediction/compensation unit 112, and a selection unit 113.

The accumulation buffer 101 accumulates encoded data that is transmitted thereto, and supplies the encoded data to the lossless decoding unit 102 at a predetermined time. The lossless decoding unit 102 decodes information that has been encoded by the lossless encoding unit of the image encoding device and is supplied from the accumulation buffer 101, by a method compatible with the encoding method used by the lossless encoding unit. The lossless decoding unit 102 supplies quantized coefficient data about the difference image obtained as a result of the decoding, to the inverse quantization unit 103.

The lossless decoding unit 102 also determines whether the prediction mode selected as an optimum prediction mode is an intra prediction mode or an inter prediction mode, and supplies information about the optimum prediction mode to the intra prediction unit 111 or the motion prediction/compensation unit 112, whichever is compatible with the mode determined to be the selected mode. For example, when an intra prediction mode is selected as the optimum prediction mode in the image encoding device, information about the intra prediction mode is supplied to the intra prediction unit 111. Also, when an inter prediction mode is selected as the optimum prediction mode in the image encoding device, for example, information about the inter prediction mode is supplied to the motion prediction/compensation unit 112.

The inverse quantization unit 103 inversely quantizes the quantized coefficient data obtained as a result of the decoding by the lossless decoding unit 102 by a method compatible with the quantization method used by the quantization unit of the image encoding device, and supplies the resultant coefficient data to the inverse orthogonal transform unit 104.

The inverse orthogonal transform unit 104 performs an inverse orthogonal transform on the coefficient data supplied from the inverse quantization unit 103, by a method compatible with the orthogonal transform method used by the orthogonal transform unit of the image encoding device. Through this inverse orthogonal transform operation, the inverse orthogonal transform unit 104 obtains decoded residual error data equivalent to the residual error data from the time prior to the orthogonal transform in the image encoding device. As will be described later in detail, the inverse orthogonal transform unit 104 performs the inverse orthogonal transform operation so as to restrict the capacity of the storage area used as the transposition register.

The decoded residual error data obtained through the inverse orthogonal transform is supplied to the arithmetic operation unit 105. A predicted image is also supplied to the arithmetic operation unit 105 from the intra prediction unit 111 or the motion prediction/compensation unit 112 via the selection unit 113.

The arithmetic operation unit 105 adds the decoded residual error data to the predicted image, and obtains decoded image data corresponding to the image data from the time prior to the predicted image subtraction performed by the arithmetic operation unit of the image encoding device. The arithmetic operation unit 105 supplies the decoded image data to the loop filter 106.

The loop filter 106 performs a loop filtering operation including a deblocking filtering operation and an adaptive loop filtering operation on the supplied decoded image, where appropriate, and supplies the resultant decoded image to the screen rearrangement buffer 107.

The loop filter 106 includes a deblocking filter, an adaptive loop filter, and the like, and, where appropriate, performs a filtering operation on the decoded image supplied from the arithmetic operation unit 105. For example, the loop filter 106 removes block distortions from the decoded image by performing a deblocking filtering operation on the decoded image. Also, the loop filter 106 improves image quality by performing a loop filtering operation using a Wiener filter on the result of the deblocking filtering operation (the decoded image from which block distortions have been removed), for example.

Alternatively, the loop filter 106 may perform any appropriate filtering operation on the decoded image. The loop filter 106 may also perform a filtering operation by using the filter coefficient supplied from the image encoding device.

The loop filter 106 supplies the result of the filtering operation (the decoded image after the filtering operation) to the screen rearrangement buffer 107 and the frame memory 109. The decoded image that is output from the arithmetic operation unit 105 can be supplied to the screen rearrangement buffer 107 and the frame memory 109 without passing through the loop filter 106. That is, the filtering operation by the loop filter 106 may be skipped.

The screen rearrangement buffer 107 performs image rearrangement. Specifically, the frame sequence rearranged in the encoding order by the screen rearrangement buffer of the image encoding device is rearranged in the original displaying order. The D/A converter 108 performs a D/A conversion on the image supplied from the screen rearrangement buffer 107, and outputs the converted image to a display (not shown) to display the image.

The frame memory 109 stores the supplied decoded image, and supplies the stored decoded image as a reference image to the selection unit 110 at a predetermined time or in response to an external request from the intra prediction unit 111 or the motion prediction/compensation unit 112 or the like.

The selection unit 110 selects a supply destination of the reference image supplied from the frame memory 109. When an intra-encoded image is decoded, the selection unit 110 supplies the reference image supplied from the frame memory 109, to the intra prediction unit 111. When an inter-encoded image is decoded, the selection unit 110 supplies the reference image supplied from the frame memory 109, to the motion prediction/compensation unit 112.

Information that has been obtained by decoding header information and indicates an intra prediction mode or the like is supplied, where appropriate, from the lossless decoding unit 102 to the intra prediction unit 111. The intra prediction unit 111 performs intra predictions in the intra prediction modes used by the intra prediction unit or the image encoding device, by using the reference image acquired from the frame memory 109. A predicted image is thus generated. The intra prediction unit 111 supplies the generated predicted image to the selection unit 113.

The motion prediction/compensation unit 112 acquires the information (such as optimum prediction mode information) obtained by decoding the header information, from the lossless decoding unit 102.

The motion prediction/compensation unit 112 performs inter predictions in the inter prediction modes used by the motion prediction/compensation unit of the image encoding device, by using the reference image acquired from the frame memory 109. A predicted image is thus generated. The motion prediction/compensation unit 112 supplies the generated predicted image to the selection unit 113.

The selection unit 113 supplies the predicted image supplied from the intra prediction unit 111 or the motion prediction/compensation unit 112 to the arithmetic operation unit 105, so that the predicted image is added to the decoded residual error data.

[Macroblocks]

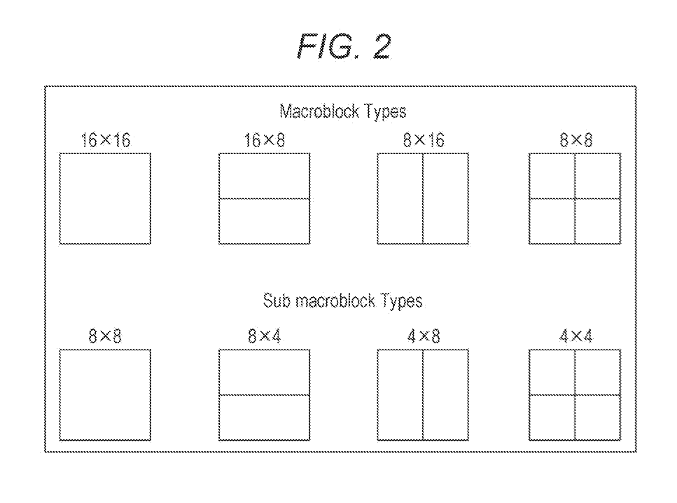

In AVC, each one macroblock formed with 16×16 pixels is divided into 16×16, 16×8, 8×16, or 8×8 parts (sub-macroblocks), as shown in FIG. 2, and those parts can have motion vector information independently of one another for each sub-macroblock. Each 8×8 part can be further divided into 8×8, 8×4, 4×8, or 4×4 sub-macroblocks that can have motion vector information independently of one another, as shown in FIG. 2.

In AVC or according to an encoding method for performing each operation for each processing unit that is the same as that in AVC, orthogonal transform operations are performed on processing units that are (4×4)-pixel sub-macroblocks or (8×8)-pixel sub-macroblocks. In short, the inverse orthogonal transform unit 104 shown in FIG. 1 performs inverse orthogonal transform operations on processing units that are (4×4)-pixel sub-macroblocks or (8×8)-pixel sub-macroblocks.

[Coding Unit]

The macroblock size of 16×16 pixels is not optimal for large frames such as UHD (Ultra High Definition: 4000×2000 pixels) frames to be encoded by a next-generation encoding method.

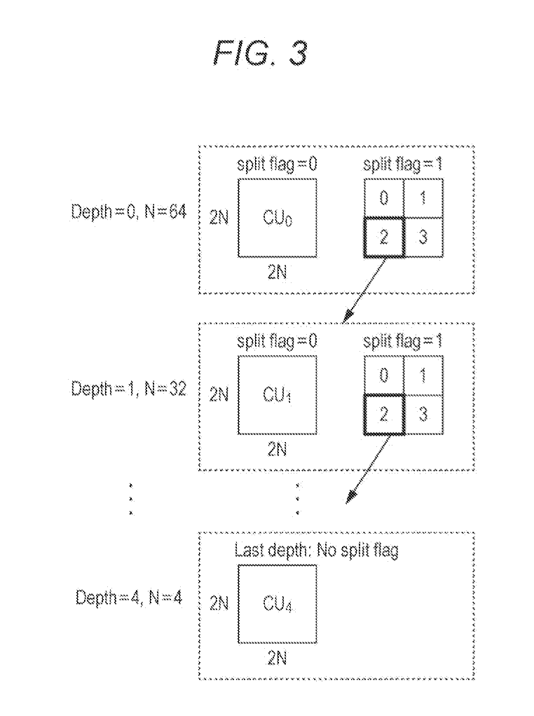

In view of this, coding units (CUs) are defined as shown in FIG. 3 in HEVC.

CUs are also called Coding Tree Blocks (CTBs), and are partial regions of picture-based images that have the same roles as those of macroblocks in AVC. While the size of the latter is limited to 16×16 pixels, the size of the former is not limited to a certain size, and may be designated by the compressed image information in each sequence.

For example, in a sequence parameter set (SPS) contained in encoded data to be output, the largest coding unit (LCU) and the smallest coding unit (SCU) of the CUs are specified.

In each LCU, split-flag=1 is set within a range not smaller than the SCU size, so that each LCU can be divided into CUs of a smaller size. In the example shown in FIG. 3, the size of the LCU is 128, and the greatest hierarchical depth is 5. When the value of split flag is “1”, a CU of 2N×2N in size is divided into CUs of N×N in size, which is one hierarchical level lower.

Each of the CUs is further divided into prediction units (PUs) that are processing unit regions (partial regions of picture-based images) for intra or inter predictions, or are divided into transform units (TUs) that are processing unit regions (partial regions of picture-based images) for orthogonal transforms. At present, 16×16 and 32×32 orthogonal transforms, as well as 4×4 and 8×8 orthogonal transforms, can be used in HEVC.

In a case where CUs are defined, and each processing operation is performed on each of the CUs in an encoding operation as in the above described HEVC, the macroblocks in AVC can be considered equivalent to the LCUs. However, a CU has a hierarchical structure as shown in FIG. 3. Therefore, the size of the LCU on the highest hierarchical level is normally as large as 128×128 pixels, which is larger than the size of each macroblock in AVC, for example.

In HEVC or according to an encoding method for performing each operation on each processing unit that is the same as in HEVC, 16×16 pixels and 32×32 pixels, as well as 4×4 pixels and 8×8 pixels, can be used as processing units for orthogonal transform operations. That is, the inverse orthogonal transform unit 104 shown in FIG. 1 can also perform inverse orthogonal transform operations on processing units that are (16×16)-pixel TUs or (32×32)-pixel TUs.

In the following, the above described macroblocks, sub-macroblocks, CUs, PUs, TUs, and the like will be also referred to as “regions”.

[Inverse Orthogonal Transform Unit]

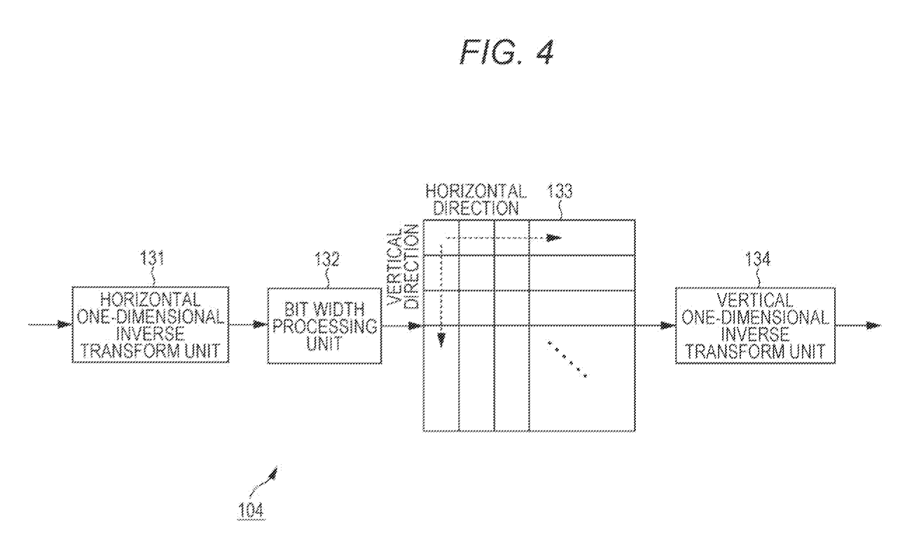

FIG. 4 is a block diagram showing a typical example structure of the inverse orthogonal transform unit 104 shown in FIG. 1.

As shown in FIG. 4, the inverse orthogonal transform unit 104 includes a horizontal one-dimensional inverse transform unit 131, a bit width processing unit 132, a transposition register 133, and a vertical one-dimensional inverse transform unit 134. The horizontal one-dimensional inverse transform unit 131, the transposition register 133, and the vertical one-dimensional inverse transform unit 134 are components that are also included in the inverse orthogonal transform unit of an image decoding device that performs decoding operations according to an encoding method such as AVC or HEVC, and the inverse orthogonal transform unit 104 includes the bit width processing unit 132 as well as those components.

The horizontal one-dimensional inverse transform unit 131 performs horizontal inverse orthogonal transforms on orthogonal transform coefficient data (hereinafter also referred to simply as coefficient data) supplied from the inverse quantization unit 103. Pieces of coefficient data that have been subjected to orthogonal transforms for respective regions of a predetermined size, such as 16×16 pixels or 32×32 pixels, are supplied to the horizontal one-dimensional inverse transform unit 131. That is, 16×16 or 32×32 coefficient data is supplied. The horizontal one-dimensional inverse transform unit 131 performs a horizontal inverse orthogonal transform on the coefficient data row by row from the top to the bottom in the vertical direction. The horizontal one-dimensional inverse transform unit 131 supplies the intermediate data obtained as a result of the inverse orthogonal transforms (the coefficient data subjected to vertical orthogonal transforms) to the bit width processing unit 132.

The bit width processing unit 132 performs a clip operation on each piece of the supplied intermediate data, and reduces the bit width of each piece of the intermediate data by an amount corresponding to the frequency band thereof. Here, a clip operation on n bits is an operation to change each value smaller than −2ⁿ⁻¹ to −2ⁿ⁻¹, and change each value larger than 2ⁿ⁻¹−1 to 2ⁿ⁻¹−1. The bit width processing unit 132 supplies each piece of the intermediate data having an adjusted bit width to the transposition register 133, which then holds the intermediate data.

The transposition register 133 stores the respective pieces of the supplied intermediate data so that the intermediate data are arranged in the order corresponding to the sequence of original orthogonal transform coefficient data, as shown in FIG. 4. That is, the transposition register 133 stores the intermediate data so that the intermediate data of the respective pixels of the respective rows is arranged in the horizontal direction, and the respective rows are adjacent to one another in the vertical direction. Accordingly, the intermediate data generated from 32×32 orthogonal transform coefficient data is stored into a (32×32×(the bit width of each pixel)) storage area.

The vertical one-dimensional inverse transform unit 134 reads the intermediate data from the transposition register 133 column by column, and performs a one-dimensional inverse orthogonal transform operation. That is, the vertical one-dimensional inverse transform unit 134 reads the intermediate data stored in the transposition register 133 from each column extending in the vertical direction. Specifically, the vertical one-dimensional inverse transform unit 134 transposes the sequence of the intermediate data from the horizontal direction to the vertical direction by performing the reading of the intermediate data from the transposition register 133 in different order from the order in which the intermediate data is written. The vertical one-dimensional inverse transform unit 134 performs vertical inverse orthogonal transforms by performing an inverse orthogonal transform on each column of the intermediate data that is read column by column in the above manner.

As the intermediate data is subjected to vertical inverse orthogonal transforms by the vertical one-dimensional inverse transform unit 134, decoded residual error data generated through inverse orthogonal transforms performed on orthogonal transform coefficient data in two dimensions (in the horizontal direction and in the vertical direction) can be obtained. The vertical one-dimensional inverse transform unit 134 supplies the decoded residual error data to the arithmetic operation unit 105.

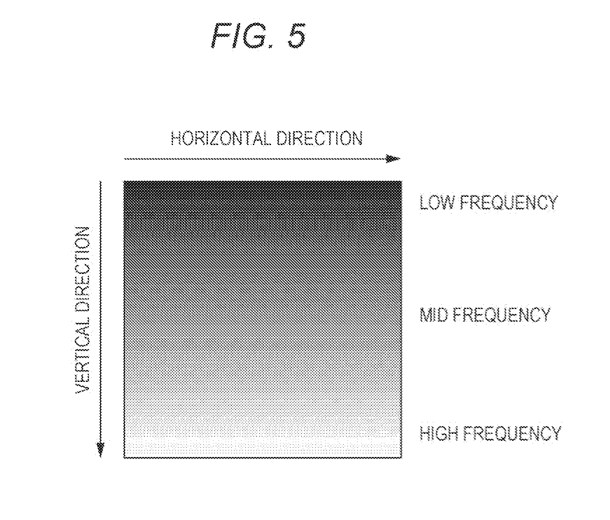

In the above described operation, the intermediate data stored in the transposition register 133 is arranged in the vertical direction in accordance with respective frequency components, as shown in FIG. 5, for example. Specifically, low-frequency components to high-frequency components are arranged from the top to the bottom. Lower-frequency components are located in upper portions, and higher-frequency components are located in lower portions. In each one row, components of the same frequency band are aligned in the horizontal direction.

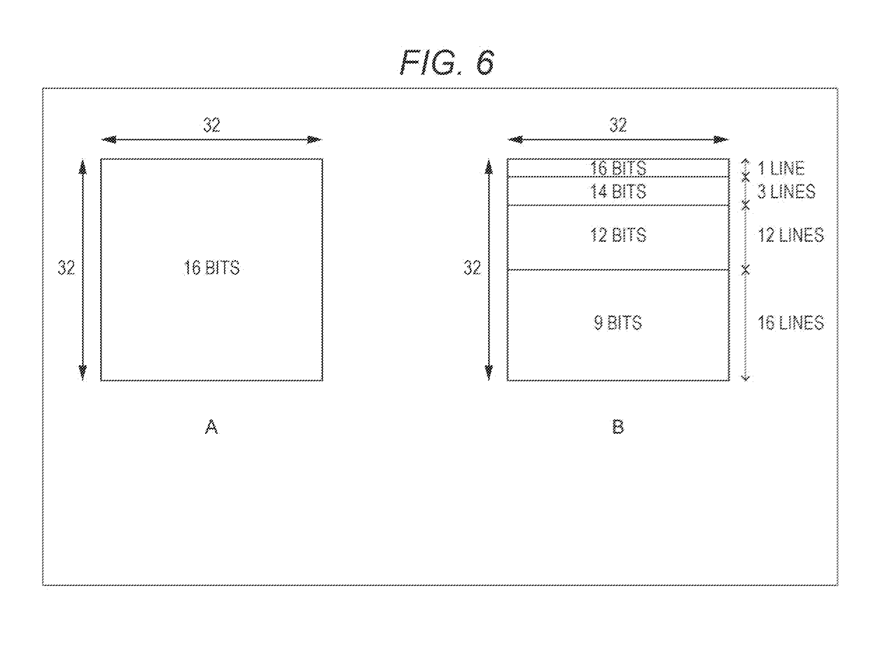

For example, the bit width of intermediate data obtained through an inverse orthogonal transform performed by the horizontal one-dimensional inverse transform unit 131 is 16 bits, as shown in A of FIG. 6. Where a processing unit region is 32×32, the data amount is (32×32)×16 bits=16,384 bits.

The bit width processing unit 132 adjusts the bit width of each piece of the intermediate data for each frequency component, for example, as shown in B of FIG. 6. More specifically, the bit width processing unit 132 restricts the bit width of each piece of the intermediate data so that a low-frequency component has a greater bit width, and a high-frequency component has a smaller bit width. In B of FIG. 6, for example, the bit width processing unit 132 restricts the bit width of the intermediate data of the first row (one horizontal line) from the top to 16 bits, and restricts the bit width of the intermediate data of each of the three rows (three horizontal lines) of the second through fourth rows from the top to 14 bits. Also, in B of FIG. 6, the bit width processing unit 132 restricts the bit width of the intermediate data of each of the 12 rows (12 horizontal lines) of the fifth through 16th rows from the top to 12 bits, and restricts the bit width of the intermediate data of each of the 16 rows (16 horizontal lines) of the 17th through 32nd rows from the top to nine bits, for example.

With this arrangement, the data amount becomes (32×1)×16 bits+(32×3)×14 bits+(32×12)×12 bits+(32×16)×9 bits=11,072 bits. Accordingly, the memory usage by the transposition register 133 can be made smaller than in the above described case where the bit width of all the intermediate data is 16 bits by 5,312 bits.

It should be noted that each row of orthogonal transform coefficient data and intermediate data may have any bit width, and may have a bit width other than the examples shown in B of FIG. 6. For example, the bit widths may be reduced four rows (four horizontal lines) at a time from the top. Also, the bit width of the intermediate data from the top to the 16th row (16 horizontal lines) may be made the same as the bit width of the orthogonal transform coefficient data, and the bit width of each of the remaining 16 rows (16 horizontal lines) may be made smaller than the bit width of the orthogonal transform coefficient data, for example.

Specifically, the bit width processing unit 132 controls the bit widths of the intermediate data in accordance with the respective frequency bands. For example, the bit width processing unit 132 reduces the bit width of the intermediate data of each horizontal line obtained by performing a horizontal one-dimensional inverse orthogonal transform on the orthogonal transform coefficient data generated as a result of a two-dimensional orthogonal transform of image data of a processing unit region, in accordance with the frequency band.

For example, the bit width processing unit 132 reduces the bit width of the intermediate data of each horizontal line of a higher-frequency component by a larger amount. In general, an image has a larger absolute value with respect to a lower-frequency component, and has a smaller absolute value with respect to a higher-frequency component. Accordingly, by controlling the bit widths in the above described manner, the bit width processing unit 132 can reduce the size of the transposition register 133 to be used in the inverse orthogonal transform operation while preventing image quality deterioration.

For example, the bit width processing unit 132 reduces the bit widths of the intermediate data of the respective horizontal lines in accordance with the frequency characteristics of orthogonally-transformed image data. By controlling the bit widths in this manner, the bit width processing unit 132 can prevent image quality deterioration more effectively.

As the size of the transposition register 133 is reduced, the memory capacity required in an image decoding operation can be reduced, and the production costs for the image decoding device 100 can be lowered accordingly.

There might be cases where intermediate data has errors due to a clip operation performed by the bit width processing unit 132. However, the influence of the errors can be reduced by securing sufficient bit widths to be clipped. In other words, the image decoding device 100 can control the degree of image quality deterioration and the size of the transposition register 133 by setting bit widths to be clipped. In view of this, it is desirable to set the bit widths to be clipped in accordance with the contents of the image so that the contents are optimized, for example.

[Decoding Operation Flow]

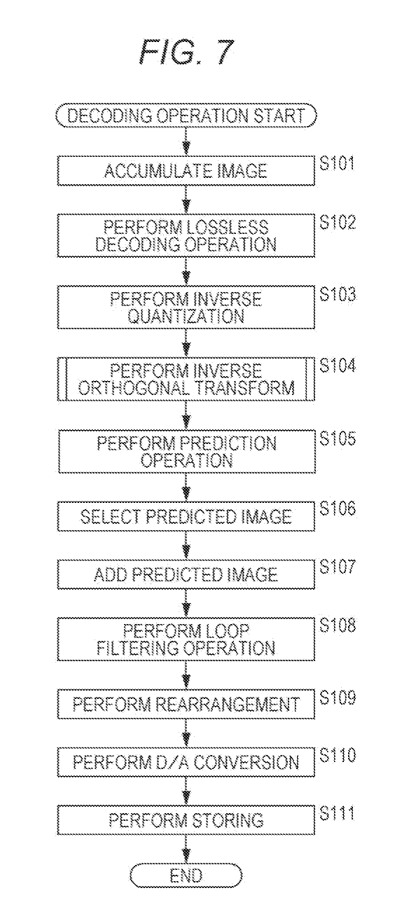

Next, the flow in each operation to be performed by the above described image decoding device 100 is described. Referring first to the flowchart shown in FIG. 7, an example flow in a decoding operation is described.

When the decoding operation is started, the accumulation buffer 101 accumulates a transmitted bit stream in step S101. In step S102, the lossless decoding unit 102 decodes the bit stream supplied from the accumulation buffer 101. Specifically, I-pictures, P-pictures, and B-pictures encoded by the lossless encoding unit of the image encoding device are decoded. Also, various kinds of information other than difference image information contained in the bit stream, such as difference motion information, are decoded.

In step S103, the inverse quantization unit 103 inversely quantizes the quantized orthogonal transform coefficient obtained in the procedure of step S102. In step S104, the inverse orthogonal transform unit 104 performs an inverse orthogonal transform on the orthogonal transform coefficient inversely quantized in step S103.

In step S105, the intra prediction unit 111 or the motion prediction/compensation unit 112 performs prediction operations using supplied information. In step S106, the selection unit 113 selects a predicted image generated in step S105. In step S107, the arithmetic operation unit 105 adds the predicted image selected in step S106 to the difference image information obtained through the inverse orthogonal transform in step S104. As a result, a decoded image is obtained.

In step S108, the loop filter 106 performs a loop filtering operation including a deblocking filtering operation and an adaptive loop filtering operation on the decoded image obtained in step S107, where appropriate.

In step S109, the screen rearrangement buffer 107 performs rearrangement on the image subjected to the filtering operation in step S108. Specifically, the order of frames rearranged for encoding by the screen rearrangement buffer of the image encoding device is rearranged in the original displaying order.

In step S110, the D/A converter 108 performs D/A conversion on the image having the order of frames rearranged in step S109. This image is output to the display (not shown), and is displayed.

In step S111, the frame memory 109 stores the image subjected to the filtering operation in step S108. This image is used as a reference image in generating predicted images in step S105.

When the procedure of step S111 is completed, the decoding operation comes to an end.

[Flow in the Inverse Orthogonal Transform Operation]

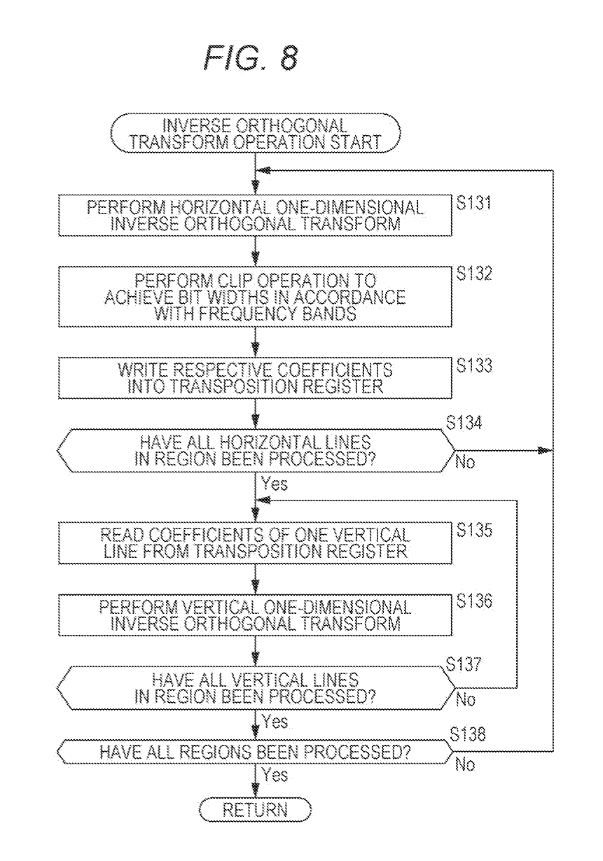

Referring now to the flowchart shown in FIG. 8, an example flow in the inverse orthogonal transform operation to be performed in step S104 of FIG. 7 is described.

In step S131, the horizontal one-dimensional inverse transform unit 131 performs a horizontal one-dimensional inverse orthogonal transform on inversely-quantized orthogonal transform coefficient data of a current horizontal line. In step S132, the bit width processing unit 132 performs a clip operation on the intermediate data of one horizontal line obtained in the procedure of step S131, to achieve a bit width in accordance with the frequency band. In step S133, the bit width processing unit 132 writes the intermediate data of the one horizontal line subjected to the clip operation into the row located one row below the previously written intermediate data of one horizontal line in the transposition register 133.

In step S134, the horizontal one-dimensional inverse transform unit 131 determines whether all the horizontal lines in the region have been processed. When it is determined that there is a horizontal line yet to be processed in the current region, the operation returns to step S131, and the procedures thereafter are carried out.

For the respective horizontal lines, the procedures of steps S131 through S134 are repeated. When it is determined in step S134 that all the horizontal lines in the current region have been processed, the horizontal one-dimensional inverse transform unit 131 moves the operation to step S135.

The vertical one-dimensional inverse transform unit 134 reads intermediate data of one vertical line from the transposition register 133 in step S135, and performs a vertical one-dimensional inverse orthogonal transform on the read intermediate data in step S136.

In step S137, the vertical one-dimensional inverse transform unit 134 determines whether all the vertical lines in the region have been processed. When it is determined that there is a vertical line yet to be processed in the current region, the operation returns to step S135, and the procedures thereafter are carried out.

For the respective vertical lines, the procedures of steps S135 through S137 are repeated. When it is determined in step S137 that all the vertical lines in the current region have been processed, the vertical one-dimensional inverse transform unit 134 moves the operation to step S138.

In step S138, the vertical one-dimensional inverse transform unit 134 determines whether all the regions in the image have been processed. When it is determined that there is a region yet to be processed, the operation returns to step S131, and the procedures thereafter are repeated.

As described above, for the respective regions, the procedures of steps S131 through S138 are repeated. When it is determined in step S138 that all the regions have been processed, the vertical one-dimensional inverse transform unit 134 ends the inverse orthogonal transform operation, and returns the operation to FIG. 7.

By carrying out the respective procedures as described above, the image decoding device 100 can reduce the data amount of the intermediate data obtained in the inverse orthogonal transform operation, and can reduce the size of the storage area used as the transposition register 133. As a result, the memory capacity required in the image decoding operation can be reduced, and the production costs for the image decoding device 100 can be lowered accordingly.

### 2. Second Embodiment

### [Inverse Orthogonal Transform Unit]

To reduce the value of each piece of intermediate data, a predetermined column (a vertical line) may be set as a reference, and difference values with respect to the reference may be stored as the intermediate data into the transposition register 133. Specifically, the differences between the same frequency components among the results of a horizontal one-dimensional inverse transform are calculated, and the differences may be set as the intermediate data.

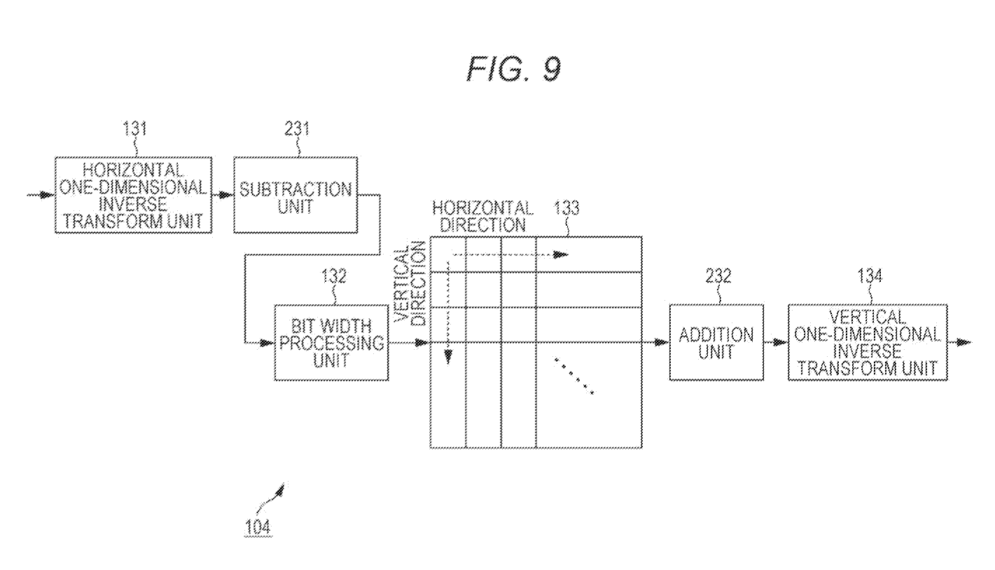

FIG. 9 is a block diagram showing another example structure of the inverse orthogonal transform unit 104.

In the example case illustrated in FIG. 9, the inverse orthogonal transform unit 104 includes not only the components described above with reference to FIG. 4, but also a subtraction unit 231 between the horizontal one-dimensional inverse transform unit 131 and the bit width processing unit 132, and an addition unit 232 between the transposition register 133 and the vertical one-dimensional inverse transform unit 134.

The subtraction unit 231 sets reference pixels that are the pixels on a predetermined vertical line among respective coefficients arranged in a matrix (an array) as described above, and calculates the difference values between the coefficients of the reference pixels and the coefficients of the respective pixels other than the reference pixels in the respective horizontal lines.

The bit width processing unit 132 performs a clip operation on the difference values output from the subtraction unit 231. For example, the bit width processing unit 132 reduces the bit width of each of the supplied difference values to a predetermined bit width, and supplies the bit widths to the transposition register 133, which then stores the bit widths as intermediate data. Also, the bit width processing unit 132 supplies the coefficients of the respective reference pixels to the transposition register 133 as they are, and the coefficients are stored as intermediate data, without a reduction in bit width.

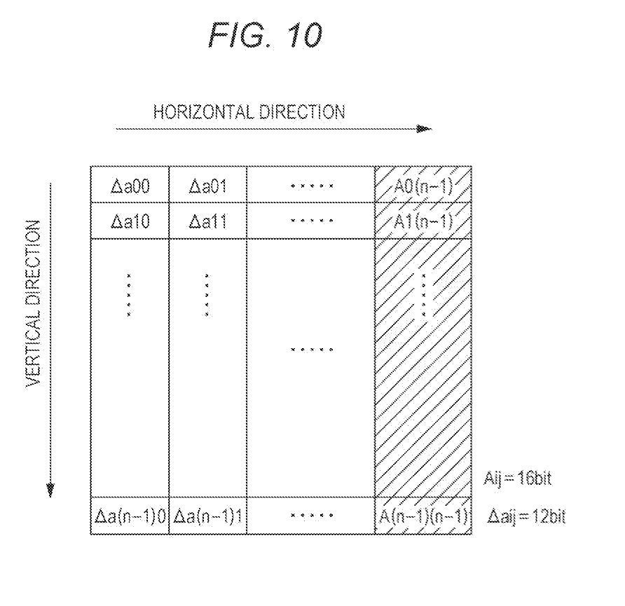

FIG. 10 is a diagram showing an example of intermediate data stored in the transposition register 133.

In the example case illustrated in FIG. 10, the size of each processing unit region in an inverse orthogonal transform operation is n×n pixels. The bit width of an output Aᵢⱼ (0≦i<n, 0≦j<n) of the horizontal one-dimensional inverse transform unit 131 is 16 bits.

The subtraction unit 231 sets the rightmost column (j=n−1) as the reference pixel line with respect to such an output, and calculates the difference values Δaᵢⱼ between the other columns (0≦j<n−1) and the coefficients of the reference pixels, as shown in the following equations (1) and (2).

Δaᵢⱼ=ABS(Aᵢⱼ)−ABS(Aᵢ₍ₙ₋₁₎) (1)

Bᵢⱼ=MBS(Aᵢⱼ) (2)

Here, Bᵢⱼ represents sign bits of Aij (0≦i<n, 0≦j<n−1).

Specifically, the subtraction unit 231 calculates the difference value between each pixel other than the reference pixel and the reference pixel located on the same horizontal line as the pixel. The subtraction unit 231 sets intermediate data formed with the difference values Δaᵢⱼ calculated in the above described manner with respect to the pixels (0≦i<n, 0≦j<n−1) other than the reference pixels, and the sign bits Bᵢⱼ, and supplies the intermediate data to the bit width processing unit 132. The subtraction unit 231 also sets intermediate data formed with 16-bit coefficients Aᵢⱼ (0≦i<n, j=n−1) with respect to the reference pixel line (0≦i<n, j=n−1), and supplies the intermediate data to the bit width processing unit 132.

As described above with reference to FIG. 5, the coefficients subjected to the horizontal one-dimensional inverse transform have the same frequency components aligned in the horizontal direction, and correlate highly with one another in the horizontal direction. Taking advantage of the high correlations, the subtraction unit 231 calculates the differences between the coefficients aligned in the horizontal direction as described above, and reduces the value of each piece of intermediate data. If subtractions with signs are performed at this point, the values might become even larger. Therefore, the subtraction unit 231 calculates the differences between the absolute values of the respective coefficients as shown in the equation (1). By doing so, the subtraction unit 231 can reduce the values of intermediate data with a higher degree of certainty.

That is, there is a high possibility that Δaij (0≦i<n, 0 j<n−1) can be expressed with smaller bit widths than Aij (0≦i<n, j=n−1). In view of this, the bit width processing unit 132 performs a clip operation on each of the supplied difference values with a smaller bit width than the original 16 bits. In the example illustrated in FIG. 10, the clip operation is performed with 12 bits. The bit width processing unit 132 reduces the bit widths of the difference values in the above manner, and supplies and stores the bit widths into the transposition register 133.

By doing so, the inverse orthogonal transform unit 104 can reduce the size of the transposition register 133 by a larger amount than in a case where all the intermediate data is stored while the bit width remains 16 bits.

As for the reference pixels, the bit width processing unit 132 transmits and stores the coefficients Aᵢⱼ (0≦i<n, j=n−1) as intermediate data into the transposition register 133. In the example case illustrated in FIG. 10, to prevent image quality deterioration, the bit width processing unit 132 stores the intermediate data Aᵢⱼ (0≦i<n, j=n−1) into the transposition register 133 (the shaded portion) while the bit width remains 16 bits. If some image quality deterioration is allowed, the intermediate data Aᵢⱼ (0≦i<n, j=n−1) may also be subjected to a clip operation to reduce bit widths at the bit width processing unit 132.

In the example illustrated in FIG. 10, n is set at 32, and Aᵢⱼ (0≦i<32, 0≦j<32) is 16 bits, for example. Where Δaᵢⱼ (0≦i<32, 0≦j<32) is 13 bits (data beyond this range being clipped to 13 bits), the data amount of intermediate data is (31×32)×13 bits+(31×32)×1 bit (sign bit)+(32×1)×16 bits=14,400 bits. With this arrangement, the data amount can be made 2,000 bits less than (32×32)×16 bits=16,384 bits, which is the data amount in a case where the bit width of all the intermediate data remains 16 bits. That is, the size of the transposition register 133 can be reduced by that amount.

The addition unit 232 reads the intermediate data of the respective reference pixels from the transposition register 133, and also reads the intermediate data (difference values) of the vertical lines other than the current reference pixel line. Each difference value is added to the intermediate data of the reference pixel located on the same horizontal line as the difference value, as shown in the following equation (3).

ABS(Aᵢⱼ)=ABS(Aᵢ₍ₙ₋₁₎)+Δaᵢⱼ(0≦i<n,0≦j<n−1) (3)

The addition unit 232 adds the sign bit Bᵢⱼ to the absolute value of Aᵢⱼ calculated as above. As a result, the respective pieces of the intermediate data of the vertical lines other than the reference pixel line are restored. The addition unit 232 supplies the intermediate data restored in the above manner to the vertical one-dimensional inverse transform unit 134. As for the reference pixels, the addition unit 232 supplies the intermediate data Aᵢⱼ read from the transposition register 133 to the vertical one-dimensional inverse transform unit 134, since the intermediate data of the reference pixels is not difference values.

The vertical one-dimensional inverse transform unit 134 performs a vertical one-dimensional inverse orthogonal transform operation on the intermediate data supplied in the above manner, and restores the image data to the same state as it was before the orthogonal transform operation. In a case where a clip operation is performed on the intermediate data as described above, there is a possibility that errors are caused by the clip operation. Therefore, the restored image data might not be completely in the same state as it was before the orthogonal transform operation in the image encoding device, but image quality deterioration due to the errors is not large. In other words, the bit widths to be subjected to the clip operation should be defined so that the image quality deterioration falls within an allowable range.

Any column may be set as the reference pixel line, but utilization efficiency of the transposition register 133 can be increased by setting the rightmost column as the reference pixel line, from the standpoint of implementation.

For example, when intermediate data is stored into the transposition register 133 as shown in the example illustrated in FIG. 10, the addition unit 232 reads the intermediate data of the reference pixels from the transposition register 133, and also reads the intermediate data of the vertical lines other than the reference pixel line one line at a time, starting from the leftmost vertical line. At this point, the intermediate data of the reference pixels is used in the adding operation for the difference values of all the vertical lines other than the reference pixel line. That is, the intermediate data of the reference pixels needs to be saved in the transposition register 133 till the end.

After the intermediate data of the vertical lines other than the reference pixel line is read, the region becomes available for use. This available region is used in saving the intermediate data of the next processing unit region. That is, as the intermediate data is read one vertical line at a time from left to right, the intermediate data of the next region can be stored one vertical line at a time from left to right.

As the rightmost vertical line is set as the reference pixel line that needs to be saved till the end, the intermediate data of the next region can be stored one vertical line at a time from left to right. Accordingly, the transposition register 133 can be more efficiently used. If some other vertical line is set as the reference pixel line, on the other hand, the intermediate data of the region to be processed next cannot be written on the reference pixel line, or it is necessary to wait until the reference pixel line becomes available for writing. As a result, the operation might become complicated, or the processing time might become unnecessarily long.

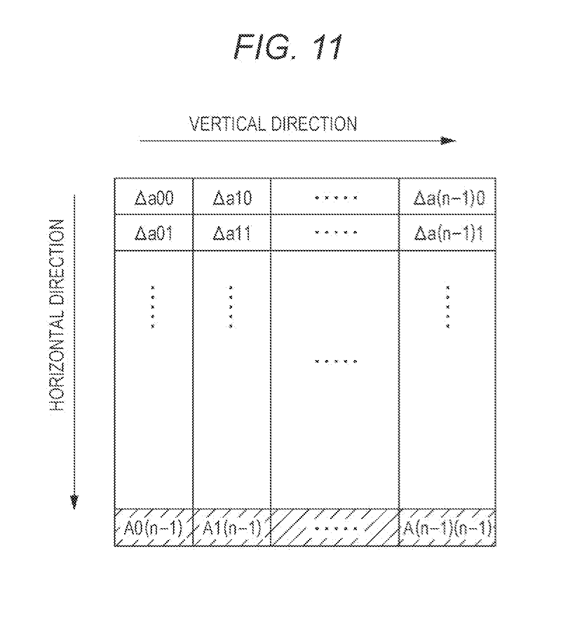

The intermediate data of the region to be processed next is written, with the horizontal direction and the vertical direction (or the rows and the columns) being transposed as shown in FIG. 11. Specifically, when the intermediate data of one vertical line is read from the transposition register 133, the one vertical line becomes available for writing, and the intermediate data of the region to be processed next is supplied one horizontal line at a time as in the case of the current region.

Accordingly, the transposition register 133 stores the intermediate data of one horizontal line on one vertical line available for writing. As writing is performed in this manner, the intermediate data of the region next to the region of the intermediate data stored in the transposition register 133 in FIG. 10 is stored, with the horizontal direction and the vertical direction being transposed as shown in FIG. 11. Accordingly, the reference pixel line is the lowest horizontal line.

Since the writing direction is changed, the reading is also performed, with the horizontal direction and the vertical direction being transposed. In the example case illustrated in FIG. 11, the intermediate data is read one horizontal line at a time. Specifically, the horizontal lines other than the reference pixel line are read one horizontal line at a time from the top to the bottom. The intermediate data of the reference pixels is read every time, and is used in the adding operation for the respective horizontal lines other than the reference pixel line.

As for the intermediate data of the region after the next, the horizontal direction and the vertical direction are again transposed, and the intermediate data of the region after the next is stored as shown in FIG. 10.

[Flow in the Inverse Orthogonal Transform Operation]

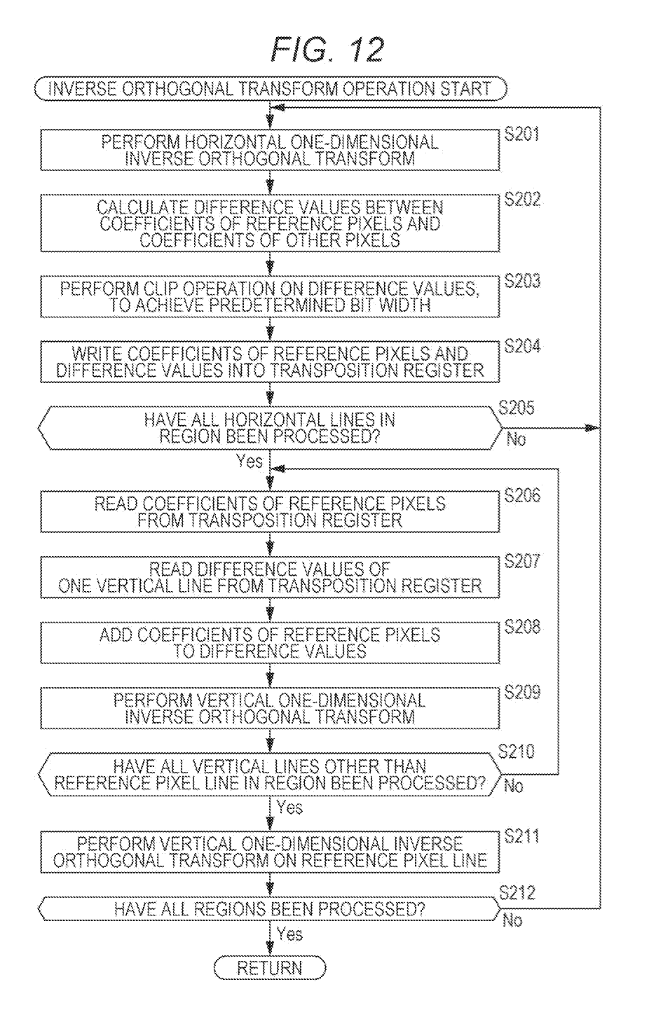

Referring now to the flowchart in FIG. 12, an example flow in the inverse orthogonal transform operation in this case is described.

In step S201, the horizontal one-dimensional inverse transform unit 131 performs a horizontal one-dimensional inverse orthogonal transform on inversely-quantized orthogonal transform coefficient data of a current horizontal line. In step S202, the subtraction unit 231 calculates the difference values Δaᵢⱼ between the coefficient of the reference pixel and the coefficients of the other pixels in the current horizontal line.

In step S203, the bit width processing unit 132 performs a clip operation on the difference values Δaᵢⱼ calculated in step S202, to reduce bit widths to a predetermined bit width that is shorter than the original bit widths. In step S204, the bit width processing unit 132 writes the difference values Δaᵢⱼ subjected to the clip operation with the coefficient of the reference pixel into the transposition register 133.

In step S205, the horizontal one-dimensional inverse transform unit 131 determines whether all the horizontal lines in the region have been processed. When it is determined that there is a horizontal line yet to be processed in the current region, the operation returns to step S201, and the procedures thereafter are carried out.

For the respective horizontal lines, the procedures of steps S201 through S205 are repeated. When it is determined in step S205 that all the horizontal lines in the current region have been processed, the horizontal one-dimensional inverse transform unit 131 moves the operation to step S206.

In step S206, the addition unit 232 reads the intermediate data of the respective reference pixels from the transposition register 133. In step S207, the addition unit 232 reads the intermediate data (difference values) of a vertical line other than the reference pixel line, from the transposition register 133. In step S208, the addition unit 232 adds the intermediate data of the reference pixel that has been read in step S206 and is located on the same horizontal line, to the respective difference values read in step S207.

In step S209, the vertical one-dimensional inverse transform unit 134 performs a vertical one-dimensional inverse orthogonal transform on the intermediate data of one vertical line obtained as a result of the addition.

In step S210, the vertical one-dimensional inverse transform unit 134 determines whether all the vertical lines other than the reference pixel line in the region have been processed. When it is determined that there is a vertical line yet to be processed among the vertical lines other than the reference pixel line in the current region, the operation returns to step S206, and the procedures thereafter are carried out.

For the respective vertical lines other than the reference pixel line, the procedures of steps S206 through S210 are repeated. When it is determined in step S210 that all the vertical lines other than the reference pixel line in the current region have been processed, the vertical one-dimensional inverse transform unit 134 moves the operation to step S211.

In step S211, the addition unit 232 reads the intermediate data of the respective reference pixels from the transposition register 133. The vertical one-dimensional inverse transform unit 134 performs a vertical one-dimensional inverse orthogonal transform on the intermediate data of the respective reference pixels.

In step S212, the vertical one-dimensional inverse transform unit 134 determines whether all the regions in the image have been processed. When it is determined that there is a region yet to be processed, the operation returns to step S201, and the procedures thereafter are repeated.

As described above, for the respective regions, the procedures of steps S201 through S212 are repeated. When it is determined in step S212 that all the regions have been processed, the vertical one-dimensional inverse transform unit 134 ends the inverse orthogonal transform operation, and returns the operation to FIG. 7.

By carrying out the respective procedures as described above, the image decoding device 100 can reduce the data amount of the intermediate data obtained in the inverse orthogonal transform operation, and can reduce the size of the storage area used as the transposition register 133. As a result, the memory capacity required in the image decoding operation can be reduced, and the production costs for the image decoding device 100 can be lowered accordingly.

[Another Example Flow in the Inverse Orthogonal Transform Operation]

In the above description, the bit width processing unit 132 performs a clip operation to adjust all the difference values to the same bit width. However, in the case of difference values calculated in the above described manner, the frequency distribution is the same as that shown in FIG. 5, as in the case of the intermediate data of the first embodiment. Therefore, the bit width processing unit 132 may control the bit widths of the respective pieces of intermediate data (difference values) in accordance with frequency bands, as in the first embodiment.

That is, the bit width processing unit 132 in FIG. 9 may adjust the bit width of each piece of the intermediate data for each frequency component, for example, as shown in B of FIG. 6. More specifically, the bit width processing unit 132 may restrict the bit width of each piece of the intermediate data so that a low-frequency component has a greater bit width, and a high-frequency component has a smaller bit width.

For example, n is set at 32, the bit width of Δaᵢⱼ (i=0, j<31) is set at 12 bits (values exceeding 12 bits are clipped to 12 bits), the bit width of Δaᵢⱼ (1≦i≦3, j<31) is set at 10 bits (values exceeding 10 bits are clipped to 10 bits), the bit width of Δaᵢⱼ (4≦i≦15, j<31) is set at eight bits (values exceeding eight bits are clipped to eight bits), and the bit width of Δaᵢⱼ (16≦i≦31, j<31) is set at six bits (values exceeding six bits are clipped to six bits). That is, the bit width of a component at a higher frequency is reduced by a larger amount.

Likewise, as for Aᵢⱼ (0≦i<n, j=31), the bit width of Aᵢⱼ (i=0, j=31) is set at 16 bits, the bit width of Aᵢⱼ (1≦i≦3, j=31) is set at 14 bits (values exceeding 14 bits are clipped to 14 bits), the bit width of Aᵢⱼ (4≦i≦15, j=31) is set at 12 bits (values exceeding 12 bits are clipped to 12 bits), and the bit width of Aᵢⱼ (16≦i≦31, j=31) is set at nine bits (values exceeding nine bits are clipped to nine bits). That is, the bit width of a component at a higher frequency is reduced by a larger amount.

As a result of this, the data amount of the intermediate data becomes (12 bits×1×31+10 bits×3×31+8 bits×12×31+6 bits×16×31)+(16 bits×1+14 bits×3+12 bits×12+9 bits×16)+1 bit×32×31=8,592 bits. Accordingly, the original data amount, (32×32)×16 bits=16,384 bits, can be reduced by 7,792 bits. That is, the memory usage by the transposition register 133 can be reduced by an equal amount.

The respective rows of orthogonal transform coefficient data and intermediate data have any bit widths, as in the first embodiment.

Specifically, in this case, the bit width processing unit 132 also controls the bit widths of the intermediate data in accordance with the respective frequency bands. For example, the bit width processing unit 132 reduces the bit widths of the intermediate data in accordance with the frequency bands. For example, the bit width processing unit 132 reduces the bit width of the intermediate data of each horizontal line of a higher-frequency component by a larger amount. By controlling the bit widths in the this manner, the bit width processing unit 132 can reduce the size of the transposition register 133 to be used in the inverse orthogonal transform operation while preventing image quality deterioration.

For example, the bit width processing unit 132 reduces the bit widths of the intermediate data of the respective horizontal lines in accordance with the frequency characteristics of orthogonally-transformed image data. By controlling the bit widths in this manner, the bit width processing unit 132 can prevent image quality deterioration more effectively.

As the size of the transposition register 133 is reduced, the memory capacity required in an image decoding operation can be reduced, and the production costs for the image decoding device 100 can be lowered accordingly.

In a case where the bit widths of the respective horizontal lines are not the same as described above, it might become difficult to store the intermediate data of the next region while transposing the horizontal direction and the vertical direction as described above with reference to FIGS. 10 and 11. In such a case, the horizontal direction and the vertical direction are not transposed, and the intermediate data of the next region may be written into the transposition register 133 after all the intermediate data of the previous region has been read.

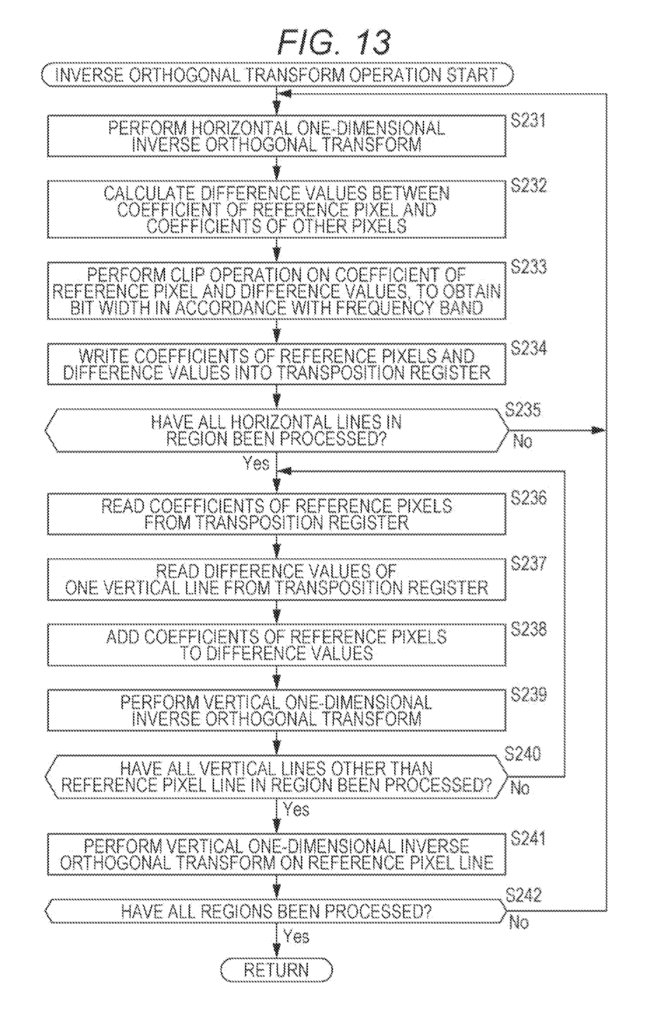

Referring now to the flowchart in FIG. 13, an example flow in the inverse orthogonal transform operation in this case is described.

The flow in the inverse orthogonal transform operation in this case is basically the same as that described above with reference to the flowchart in FIG. 12. Specifically, the respective procedures of steps S231 through S242 are carried out in the same manner as the respective procedures of steps S201 through S212 of FIG. 12.

In step S233, however, the bit width processing unit 132 performs a clip operation on difference values to reduce bit widths in accordance with the frequency band. The bit width processing unit 132 also performs a clip operation on the intermediate data of the reference pixel to reduce the bit width in accordance with the frequency band in the same manner.

By doing so, the inverse orthogonal transform unit 104 can reduce the size of the transposition register 133 while preventing image quality deterioration more effectively than in the case shown in FIG. 12.

### 3. Third Embodiment

### [Inverse Orthogonal Transform Unit]

Instead of the above described reference pixels, the mean value of the intermediate data in each horizontal line may be calculated and set as a reference, and the differences between the coefficients of respective pixels and the mean value may be set as intermediate data.

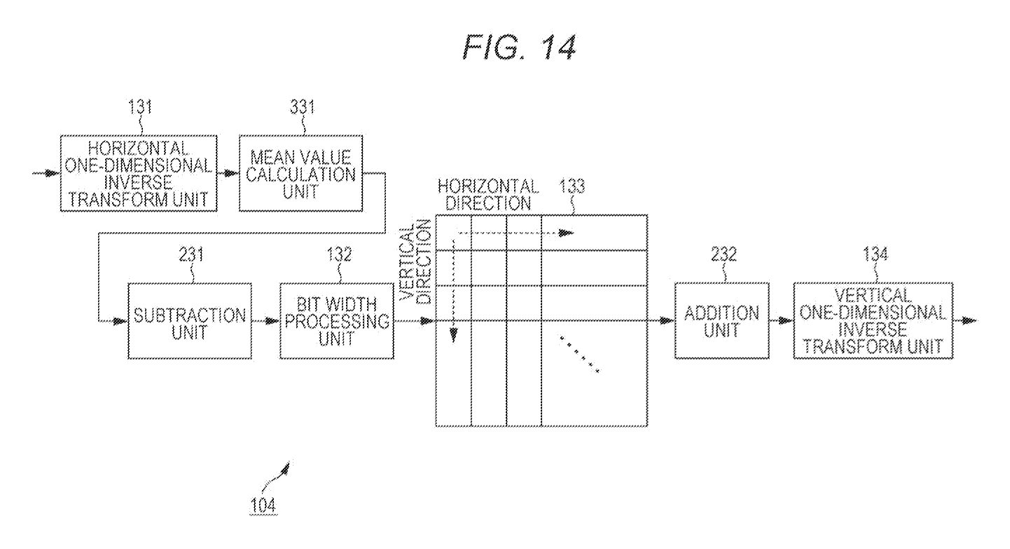

FIG. 14 shows an example structure of the inverse orthogonal transform unit 104 in this case.

As shown in FIG. 14, the inverse orthogonal transform unit 104 in this case includes not only the components shown in FIG. 9, but also a mean value calculation unit 331 between the horizontal one-dimensional inverse transform unit 131 and the subtraction unit 231.

With respect to the output of the horizontal one-dimensional inverse transform unit 131, the mean value calculation unit 331 calculates the mean value of (the absolute values of) the respective coefficients of each horizontal line, as shown in the following equation (4), for example.

μᵢ=(ABS(Aᵢ₀)+ABS(Aᵢ₁)+ . . . +ABS(Aᵢₙ))/n(0≦i<n) (4)

The mean value calculation unit 331 supplies the output of the horizontal one-dimensional inverse transform unit 131 and the calculated mean values μ_{d} to the subtraction unit 231.

In each horizontal line, the subtraction unit 231 calculates the difference values between the coefficients of the respective pixels and the mean value, as shown in the following equations (5) and (6), for example.

Δaᵢⱼ=ABS(Aᵢⱼ)−μᵢ(0≦i<n,0≦j<n−1) (5)

Bᵢⱼ=MBS(Aᵢⱼ)(0≦i<n,0≦j<n−1) (6)

Here, Bᵢⱼ represents the sign bit of Aᵢⱼ (0≦i<n, 0≦j<n−1). The subtraction unit 231 supplies the calculated difference values (including sign bits) and the mean values to the bit width processing unit 132.

The bit width processing unit 132 performs a clip operation on the difference values output from the subtraction unit 231 at predetermined bit widths so as to reduce bit widths. The bit width processing unit 132 supplies and stores intermediate data that are the difference values and sign bits subjected to the clip operation, into the transposition register 133. The bit width processing unit 132 also supplies and stores the mean values supplied from the subtraction unit 231, into the transposition register 133.

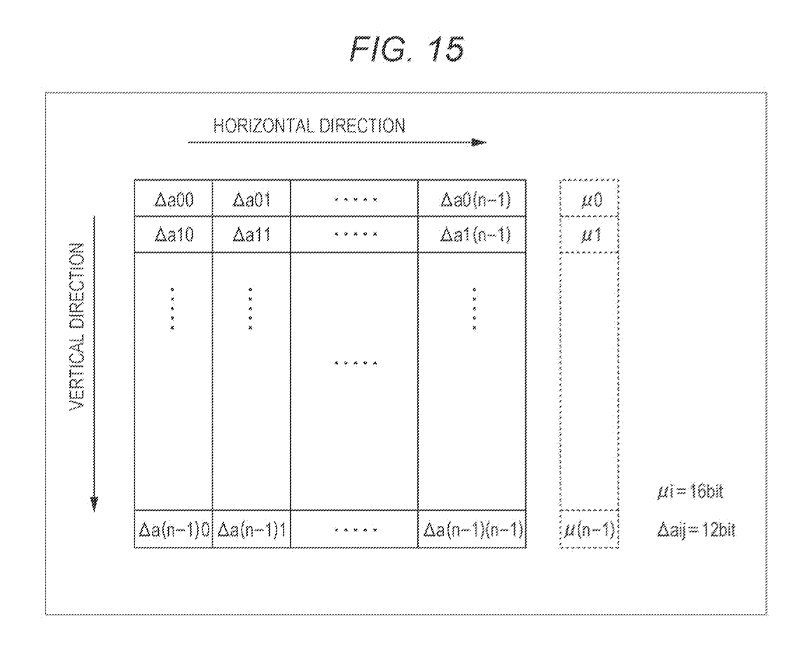

In this case, the intermediate data of all the pixels is difference values, as shown in FIG. 15. Also, the respective mean values μᵢ calculated in the respective horizontal lines are also stored in the transposition register 133. (Sign bits are not shown in the drawing.)

The bit width processing unit 132 stores the mean values and sign bits into the transposition register 133, without a reduction in bit width. If some image quality deterioration is allowed, those values may also be subjected to a clip operation to reduce bit widths at the bit width processing unit 132.

The addition unit 232 reads, from the transposition register 133, the intermediate data (the difference values) one vertical line at a time, and the mean values μᵢ. The addition unit 232 adds the mean value μ_{d} of the same horizontal line as the read difference values to the difference values, as shown in the following equation (7).

ABS(Aᵢⱼ)=Δaᵢⱼ+μᵢ(0≦i<n,0≦j<n−1) (7)

The addition unit 232 adds the sign bit Bᵢⱼ to the absolute value of Aᵢⱼ calculated as above. As a result, each piece of intermediate data is restored. The addition unit 232 supplies the intermediate data restored in the above manner to the vertical one-dimensional inverse transform unit 134.

The vertical one-dimensional inverse transform unit 134 performs a vertical one-dimensional inverse orthogonal transform operation on the intermediate data supplied in the above manner, and restores the image data to the same state as it was before the orthogonal transform operation.

As described above, by this method, all the intermediate data can be expressed as difference values, and control on the repetitive operations can be made easier. In this case, however, the transposition register 133 needs to store the mean values μᵢ, and its capacity needs to be increased accordingly. However, the mean values are calculated from coefficients that correlate highly with one another, and, with such mean values, the possibility that fewer difference values are obtained becomes higher. Accordingly, the bit width processing unit 132 can further reduce bit widths while preventing an increase in image quality deterioration. Thus, the inverse orthogonal transform unit 104 can further reduce the size of the transposition register 133.

[Flow in the Inverse Orthogonal Transform Operation]

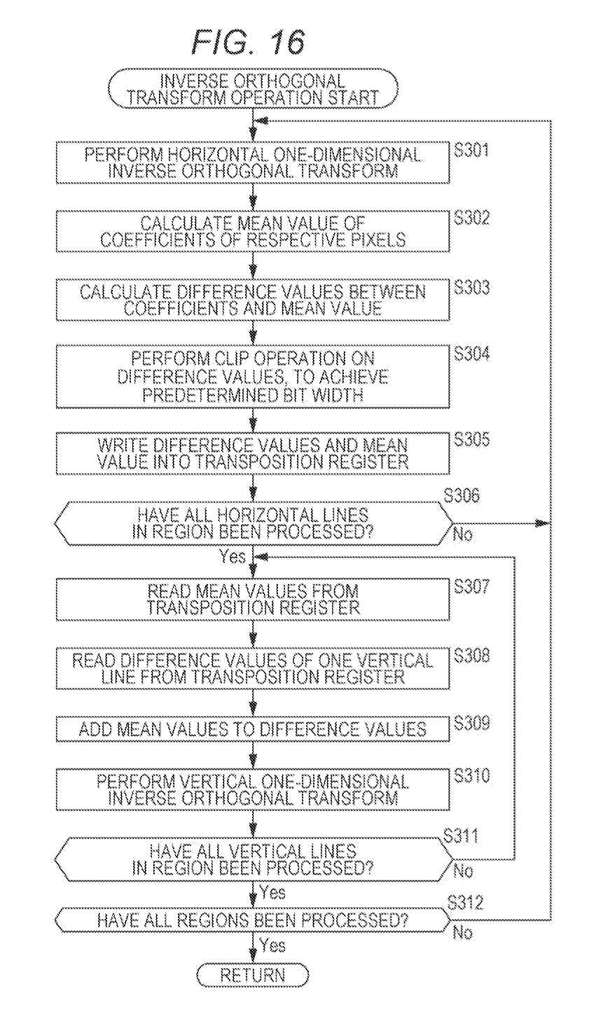

Referring now to the flowchart in FIG. 16, an example flow in the inverse orthogonal transform operation in this case is described.

In step S301, the horizontal one-dimensional inverse transform unit 131 performs a horizontal one-dimensional inverse orthogonal transform on inversely-quantized orthogonal transform coefficient data of a current horizontal line. In step S302, the mean value calculation unit 331 calculates the mean value μ_{d} of the coefficients Aᵢⱼ of the respective pixels of the current horizontal line.

In step S303, the subtraction unit 231 calculates the difference values Δaᵢⱼ between the respective coefficients Aᵢⱼ of the current horizontal line and the mean value μ_{d} calculated in step S302.

In step S304, the bit width processing unit 132 performs a clip operation on the difference values calculated in step S303, to reduce bit widths to a predetermined bit width that is shorter than the original bit widths. In step S305, the bit width processing unit 132 writes the difference values Δaᵢⱼ′ (including sign bits Bᵢⱼ) subjected to the clip operation and the mean value μ_{d} into the transposition register 133.

In step S306, the horizontal one-dimensional inverse transform unit 131 determines whether all the horizontal lines in the region have been processed. When it is determined that there is a horizontal line yet to be processed in the current region, the operation returns to step S301, and the procedures thereafter are carried out.

For the respective horizontal lines, the procedures of steps S301 through S306 are repeated. When it is determined in step S306 that all the horizontal lines in the current region have been processed, the horizontal one-dimensional inverse transform unit 131 moves the operation to step S307.

In step S307, the addition unit 232 reads each mean value μ_{d} from the transposition register 133. In step S308, the addition unit 232 reads the intermediate data (difference values) of the current vertical line from the transposition register 133. In step S309, the addition unit 232 adds the mean value that has been read in step S307 and is located on the same horizontal line as the difference values read in step S308, to the respective difference values read in step S308.

In step S310, the vertical one-dimensional inverse transform unit 134 performs a vertical one-dimensional inverse orthogonal transform on the intermediate data of one vertical line obtained as a result of the addition.

In step S311, the vertical one-dimensional inverse transform unit 134 determines whether all the vertical lines in the region have been processed. When it is determined that there is a vertical line yet to be processed in the current region, the operation returns to step S307, and the procedures thereafter are carried out.

For the respective vertical lines in the region, the procedures of steps S307 through S311 are repeated. When it is determined in step S311 that all the vertical lines in the current region have been processed, the vertical one-dimensional inverse transform unit 134 moves the operation to step S312.

In step S312, the vertical one-dimensional inverse transform unit 134 determines whether all the regions in the image have been processed. When it is determined that there is a region yet to be processed, the operation returns to step S301, and the procedures thereafter are repeated.

As described above, for the respective regions, the procedures of steps S301 through S312 are repeated. When it is determined in step S312 that all the regions have been processed, the vertical one-dimensional inverse transform unit 134 ends the inverse orthogonal transform operation, and returns the operation to FIG. 7.

By carrying out the respective procedures as described above, the image decoding device 100 can reduce the data amount of the intermediate data obtained in the inverse orthogonal transform operation, and can reduce the size of the storage area used as the transposition register 133. As a result, the memory capacity required in the image decoding operation can be reduced, and the production costs for the image decoding device 100 can be lowered accordingly.

[Another Example Flow in the Inverse Orthogonal Transform Operation]

In the above description, the bit width processing unit 132 performs a clip operation to adjust all the difference values to the same bit width. However, in the case of difference values calculated in the above described manner, the frequency distribution is the same as that shown in FIG. 5, as in the case of the intermediate data of the first embodiment. Therefore, the bit width processing unit 132 may control the bit widths of the respective pieces of intermediate data (difference values) in accordance with frequency bands, as in the first embodiment.

That is, the bit width processing unit 132 in FIG. 14 may adjust the bit width of each piece of intermediate data for each frequency component, for example, as shown in B of FIG. 6. More specifically, the bit width processing unit 132 may restrict the bit width of each piece of intermediate data so that a low-frequency component has a greater bit width, and a high-frequency component has a smaller bit width.

By doing so, the image decoding device 100 can reduce memory usage by the transposition register 133, as in the second embodiment.

The respective rows of orthogonal transform coefficient data and intermediate data have any bit widths, as in the first embodiment.

Specifically, in this case, the bit width processing unit 132 also controls the bit widths of the intermediate data in accordance with the respective frequency bands. For example, the bit width processing unit 132 reduces the bit widths of the intermediate data in accordance with the frequency bands. For example, the bit width processing unit 132 reduces the bit width of the intermediate data of each horizontal line of a higher-frequency component by a larger amount. By controlling the bit widths in the this manner, the bit width processing unit 132 can reduce the size of the transposition register 133 to be used in the inverse orthogonal transform operation while preventing image quality deterioration.

For example, the bit width processing unit 132 reduces the bit widths of the intermediate data of the respective horizontal lines in accordance with the frequency characteristics of orthogonally-transformed image data. By controlling the bit widths in this manner, the bit width processing unit 132 can prevent image quality deterioration more effectively.

As the size of the transposition register 133 is reduced, the memory capacity required in an image decoding operation can be reduced, and the production costs for the image decoding device 100 can be lowered accordingly.

[Flow in the Inverse Orthogonal Transform Operation]

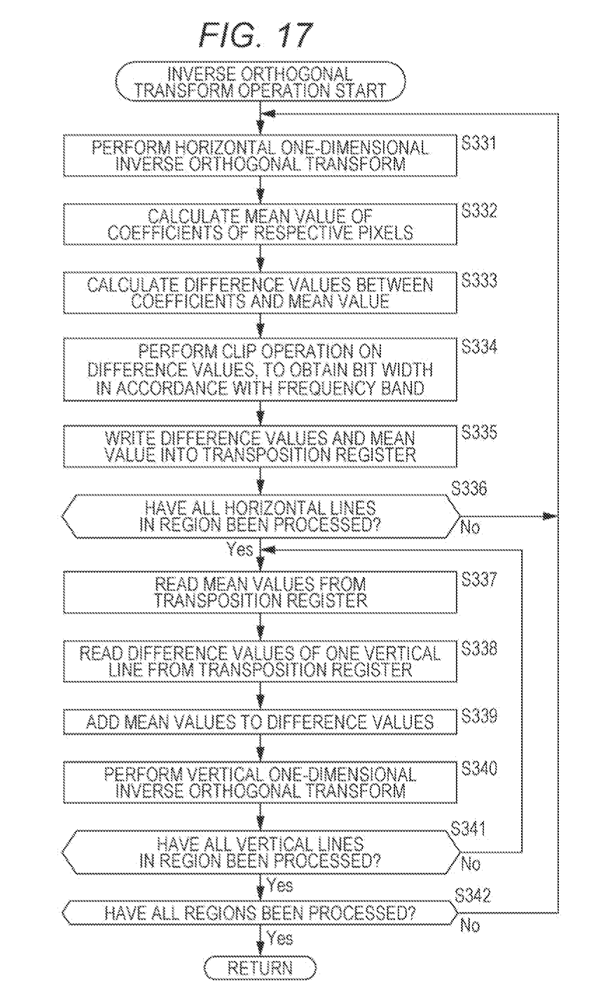

Referring now to the flowchart in FIG. 17, an example flow in the inverse orthogonal transform operation in this case is described.

The flow in the inverse orthogonal transform operation in this case is basically the same as that described above with reference to the flowchart in FIG. 16. Specifically, the respective procedures of steps S331 through S342 are carried out in the same manner as the respective procedures of steps S301 through S312 of FIG. 16.

In step S334, however, the bit width processing unit 132 performs a clip operation on difference values to reduce bit widths in accordance with the frequency band.

By doing so, the inverse orthogonal transform unit 104 can reduce the size of the transposition register 133 while preventing image quality deterioration more effectively than in the case illustrated in FIG. 16.

Although the mean values are used as references in the above description, the invention is not limited to that, and the median value of the respective coefficient data of one horizontal line may be used as a reference, for example. In this case, the value closest to the center of the range of the coefficient data values is selected as the median value from the respective pieces of coefficient data of one horizontal line. Other than the use of the median values in place of the mean values, the same operation as above is performed in this case. Normally, selecting median values is easier than calculating mean values. Also, one of the difference values in one horizontal line is certainly changed to zero.

### 4. Fourth Embodiment

### [Image Encoding Device]

An image encoding device compatible with the above described image decoding device also includes the same inverse orthogonal transform unit as the above described inverse orthogonal transform unit 104. Accordingly, at the inverse orthogonal transform unit of such an image encoding device, the size of the transposition register can be reduced by performing operations in the same manner as in any of the above described methods.

Such an image encoding device also includes an orthogonal transform unit compatible with the inverse orthogonal transform unit 104. Operations may be performed at the orthogonal transform unit in the same manner as in any of the above described methods. As a result, the size of the transposition register provided in the orthogonal transform unit can be reduced.

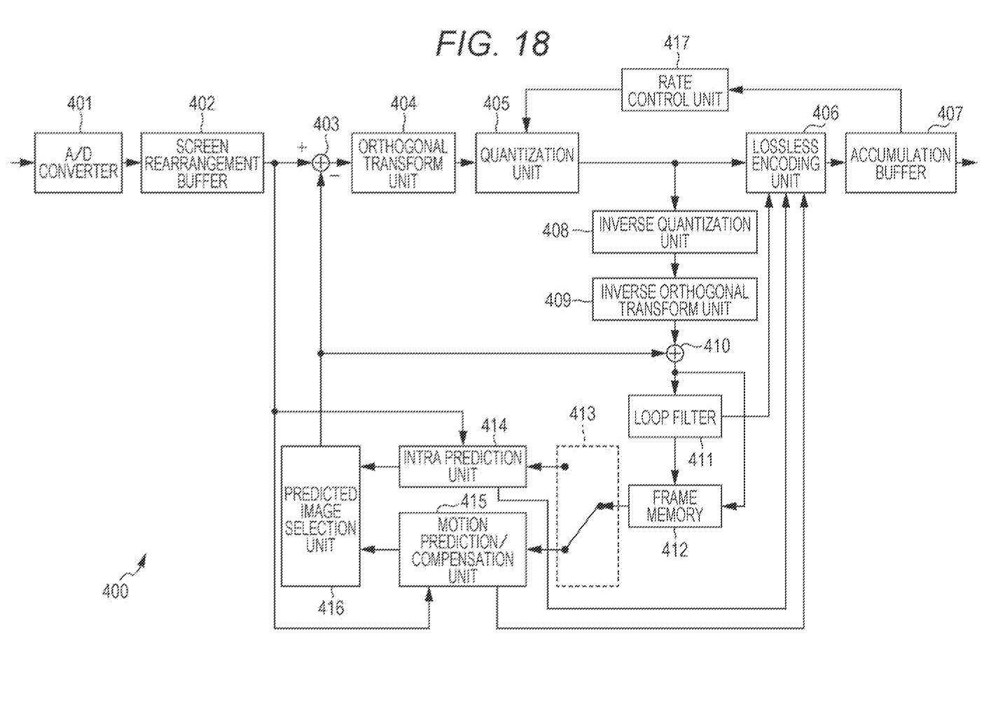

FIG. 18 is a block diagram showing a typical example structure of an image encoding device that is an embodiment of an image processing device. The image encoding device 400 shown in FIG. 18 is a device compatible with the image decoding device 100 shown in FIG. 1, and generates encoded data (bit streams) by encoding image data according to an encoding method (such as MPEG, AVC, or HEVC) compatible with the decoding method used by the image decoding device 100. The encoded data can be decoded by the image decoding device 100.

As shown in FIG. 18, the image encoding device 400 includes an A/D converter 401, a screen rearrangement buffer 402, an arithmetic operation unit 403, an orthogonal transform unit 404, a quantization unit 405, a lossless encoding unit 406, and an accumulation buffer 407. The image encoding device 400 also includes an inverse quantization unit 408, an inverse orthogonal transform unit 409, an arithmetic operation unit 410, a loop filter 411, a frame memory 412, a selection unit 413, an intra prediction unit 414, a motion prediction/compensation unit 415, a predicted image selection unit 416, and a rate control unit 417.

The A/D converter 401 subjects input image data to an A/D conversion, and supplies and stores the converted image data (digital data) into the screen rearrangement buffer 402. The screen rearrangement buffer 402 rearranges the image having frames stored in displaying order in accordance with the GOP (Group of Pictures) structure, so that the frames are arranged in frame order for encoding. The image having the frames rearranged is supplied to the arithmetic operation unit 403. The screen rearrangement buffer 402 also supplies the image having the rearranged frame order to the intra prediction unit 414 and the motion prediction/compensation unit 415.

The arithmetic operation unit 403 subtracts a predicted image supplied from the intra prediction unit 414 or the motion prediction/compensation unit 415 via the predicted image selection unit 416, from the image read from the screen rearrangement buffer 402, and outputs the difference information to the orthogonal transform unit 404.

When inter encoding is performed on an image, for example, the arithmetic operation unit 403 subtracts a predicted image supplied from the motion prediction/compensation unit 415, from the image read from the screen rearrangement buffer 402.

The orthogonal transform unit 404 performs an orthogonal transform, such as a discrete cosine transform or a Karhunen-Loeve transform, on the difference information supplied from the arithmetic operation unit 403. This orthogonal transform is performed by any appropriate method. The orthogonal transform unit 404 supplies the transform coefficient to the quantization unit 405.

The quantization unit 405 quantizes the transform coefficient supplied from the orthogonal transform unit 404. Based on target bit rate value information supplied from the rate control unit 417, the quantization unit 405 sets a quantization parameter, and performs quantization. This quantization is performed by any appropriate method. The quantization unit 405 supplies the quantized transform coefficient to the lossless encoding unit 406.

The lossless encoding unit 406 encodes the transform coefficient quantized at the quantization unit 405 by an appropriate encoding method. Since the coefficient data has already been quantized under the control of the rate control unit 417, the bit rate becomes equal to the target value (or approximates the target value) that has been set by the rate control unit 417.

The lossless encoding unit 406 obtains information indicating an intra prediction mode and the like from the intra prediction unit 414, and obtains information indicating an inter prediction mode, motion vector information, and the like from the motion prediction/compensation unit 415. The lossless encoding unit 406 further obtains the filter coefficient and the like used at the loop filter 411.

The lossless encoding unit 406 encodes those various kinds of information by an appropriate encoding method, and incorporates the information into (or multiplexes the information with) the header information of the encoded data. The lossless encoding unit 406 supplies and stores the encoded data obtained through the encoding into the accumulation buffer 407.

The encoding method used by the lossless encoding unit 406 may be variable-length encoding or arithmetic encoding, for example. The variable-length encoding may be CAVLC (Context-Adaptive Variable Length Coding) specified in H.264/AVC, for example. The arithmetic encoding may be CABAC (Context-Adaptive Binary Arithmetic Coding), for example.

The accumulation buffer 407 temporarily holds the encoded data supplied from the lossless encoding unit 406. The accumulation buffer 407 outputs the encoded data held therein to a recording device (a recording medium) or a transmission path or the like (not shown) in a later stage, for example, at a predetermined time.

The transform coefficient quantized at the quantization unit 405 is also supplied to the inverse quantization unit 408. The inverse quantization unit 408 inversely quantizes the quantized transform coefficient by a method compatible with the quantization performed by the quantization unit 405. The inverse quantization method may be any method as long as the method is compatible with the quantization operation performed by the quantization unit 405. The inverse quantization unit 408 supplies the obtained transform coefficient to the inverse orthogonal transform unit 409.

The inverse orthogonal transform unit 409 performs an inverse orthogonal transform on the transform coefficient supplied from the inverse quantization unit 408, by a method compatible with the orthogonal transform operation performed by the orthogonal transform unit 404. This inverse orthogonal transform may be performed by any method as long as the method is compatible with the orthogonal transform operation performed by the orthogonal transform unit 404. The output subjected to the inverse orthogonal transform (the restored difference information) is supplied to the arithmetic operation unit 410.

The arithmetic operation unit 410 obtains a locally decoded image (a decoded image) by adding the predicted image supplied from the intra prediction unit 414 or the motion prediction/compensation unit 415 via the predicted image selection unit 416 to the inverse orthogonal transform result supplied from the inverse orthogonal transform unit 409 or the restored difference information. The decoded image is supplied to the loop filter 411 or the frame memory 412.

The loop filter 411 includes a deblocking filter, an adaptive loop filter, and the like, and, where appropriate, performs a filtering operation on the decoded image supplied from the arithmetic operation unit 410. For example, the loop filter 411 removes block distortions from the decoded image by performing a deblocking filtering operation on the decoded image. Also, the loop filter 411 improves image quality by performing a loop filtering operation using a Wiener filter on the result of the deblocking filtering operation (the decoded image from which block distortions have been removed), for example.

Alternatively, the loop filter 411 may perform any appropriate filtering operation on the decoded image. Also, the loop filter 411 can supply the information such as the filter coefficient used in the filtering operation to the lossless encoding unit 406 to encode the information, where necessary.

The loop filter 411 supplies the result of the filtering operation (the decoded image after the filtering operation) to the frame memory 412. As described above, the decoded image that is output from the arithmetic operation unit 410 can be supplied to the frame memory 412 without passing through the loop filter 411. That is, the filtering operation by the loop filter 411 may be skipped.

The frame memory 412 stores the supplied decoded image, and supplies the stored decoded image as a reference image to the selection unit 413 at a predetermined time.

The selection unit 413 selects a supply destination of the reference image supplied from the frame memory 412. In the case of an inter prediction, for example, the selection unit 413 supplies the reference image supplied from the frame memory 412, to the motion prediction/compensation unit 415.

The intra prediction unit 414 performs intra predictions (intra-screen predictions) to generate a predicted image by using the pixel values in the current picture that is the reference image supplied from the frame memory 412 via the selection unit 413. In the generation of the predicted image, a prediction unit (PU) is used basically as a unit of processing. The intra prediction unit 414 performs intra predictions in more than one mode (intra prediction modes) that is prepared in advance.

The intra prediction unit 414 generates predicted images in all the candidate intra prediction modes, evaluates the cost function values of the respective predicted images by using the input image supplied from the screen rearrangement buffer 402, and selects an optimum mode. After selecting the optimum intra prediction mode, the intra prediction unit 414 supplies the predicted image generated in the optimum intra prediction mode to the predicted image selection unit 416.

As described above, the intra prediction unit 414 also supplies the intra prediction mode information indicating the adopted intra prediction mode, to the lossless encoding unit 406 to encode the intra prediction mode information, where appropriate.

Using the input image supplied from the screen rearrangement buffer 402, and the reference image supplied from the frame memory 412 via the selection unit 413, the motion prediction/compensation unit 415 performs motion predictions (inter predictions), and performs a motion compensation operation in accordance with the detected motion vectors, to generate a predicted image (inter predicted image information). In the motion predictions, a PU is used basically as a unit of processing. The motion prediction/compensation unit 415 performs such inter predictions in more than one mode (inter prediction modes) that is prepared in advance.

The motion prediction/compensation unit 415 generates predicted images in all the candidate inter prediction modes, evaluates the cost function values of the respective predicted images, and selects an optimum mode. After selecting the optimum inter prediction mode, the motion prediction/compensation unit 415 supplies the predicted image generated in the optimum intra prediction mode to the predicted image selection unit 416.

When the information indicating the selected inter prediction mode and encoded data are decoded, the motion prediction/compensation unit 415 supplies the necessary information for performing operations in the inter prediction mode, to the lossless encoding unit 406 to encode the information.

The predicted image selection unit 416 selects the supplier of the predicted image to be supplied to the arithmetic operation unit 403 and the arithmetic operation unit 410. In the case of inter encoding, for example, the predicted image selection unit 416 selects the motion prediction/compensation unit 415 as the supplier of an predicted image, and supplies the predicted image supplied from the motion prediction/compensation unit 415, to the arithmetic operation unit 403 and the arithmetic operation unit 410.

Based on the bit rate of the encoded data accumulated in the accumulation buffer 407, the rate control unit 417 controls the quantization operation rate of the quantization unit 405 so as not to cause an overflow or underfloor.

In FIG. 18, the inverse orthogonal transform unit 409 is the same operation unit as the inverse orthogonal transform unit 104 of the image decoding device 100 described above in the first through third embodiments, and performs the same operations as the inverse orthogonal transform unit 104. Specifically, like the inverse orthogonal transform unit 104, the inverse orthogonal transform unit 409 has a transposition register 133, and can reduce the size of the transposition register 133 by performing an inverse orthogonal transform operation by any of the above described methods.

Also, in FIG. 18, the orthogonal transform unit 404 is an operation unit that is compatible with the inverse orthogonal transform unit 409 (or the inverse orthogonal transform unit 104), and performs an orthogonal transform operation corresponding to the inverse orthogonal transform operation to be performed by the inverse orthogonal transform unit 409. Specifically, this orthogonal transform unit 404 also has the same transposition register as that of the inverse orthogonal transform unit 104, and can reduce the size of the transposition register by performing an orthogonal transform operation corresponding to the inverse orthogonal transform operation to be performed by any of the above described methods.

[Orthogonal Transform Unit]

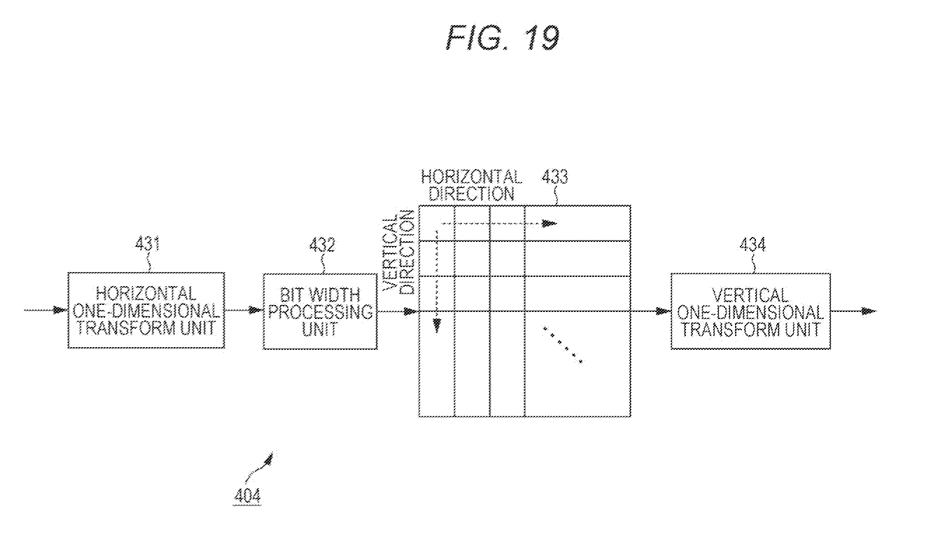

FIG. 19 is a block diagram showing a typical example structure of the orthogonal transform unit 404. As shown in FIG. 19, the orthogonal transform unit 404 includes a horizontal one-dimensional transform unit 431, a bit width processing unit 432, a transposition register 433, and a vertical one-dimensional transform unit 434. In other words, the orthogonal transform unit 404 has substantially the same structure as the inverse orthogonal transform unit 104 of the first embodiment shown in FIG. 4.

The horizontal one-dimensional transform unit 431 is an operation unit compatible with the horizontal one-dimensional inverse transform unit 131, and performs a horizontal one-dimensional orthogonal transform on image data one horizontal line at a time. The image data is of a processing unit region for orthogonal transform operations, and is input one horizontal line at a time. Specifically, the coefficient data obtained by the horizontal one-dimensional transform unit 431 performing a horizontal one-dimensional orthogonal transform on the image data can be inversely transformed (into the original image data) (or can be subjected to a horizontal one-dimensional inverse orthogonal transform) by the horizontal one-dimensional inverse transform unit 131.

The coefficient data generated by the horizontal one-dimensional transform unit 431 is supplied to the bit width processing unit 432. The bit width processing unit 432 performs a clip operation on each piece of the coefficient data (intermediate data) output from the horizontal one-dimensional transform unit 431, so as to reduce bit widths. At this point, the bit width processing unit 432 reduces the bit width of each piece of the intermediate data in accordance with the frequency band. The bit width processing unit 432 supplies each piece of the intermediate data having an adjusted bit width to the transposition register 433, which then holds the intermediate data.

Like the transposition register 133, the transposition register 433 stores the respective pieces of the supplied intermediate data so that the intermediate data are arranged in the order corresponding to the sequence of original orthogonal transform coefficient data, as shown in FIG. 19.

The vertical one-dimensional transform unit 434 is an operation unit compatible with the vertical one-dimensional inverse transform unit 134. The vertical one-dimensional transform unit 434 reads the intermediate data from the transposition register 433 a vertical line at a time, and performs a one-dimensional orthogonal transform operation. That is, the vertical one-dimensional transform unit 434 reads the intermediate data stored in the transposition register 433 from each column extending in the vertical direction. Specifically, the vertical one-dimensional transform unit 434 transposes the sequence of the intermediate data from the horizontal direction to the vertical direction by performing the reading of the intermediate data from the transposition register 433 in different order from the order in which the intermediate data is written. The vertical one-dimensional transform unit 434 performs an orthogonal transform on each vertical line of the intermediate data that has been read from each column, and realizes a vertical orthogonal transform.

As the intermediate data is subjected to the vertical orthogonal transform by the vertical one-dimensional transform unit 434, orthogonal transform coefficient data (also referred to simply as coefficient data) obtained by performing an orthogonal transform on image data in two dimensions (the horizontal direction and the vertical direction) is obtained. The vertical one-dimensional transform unit 434 supplies the coefficient data to the quantization unit 405.

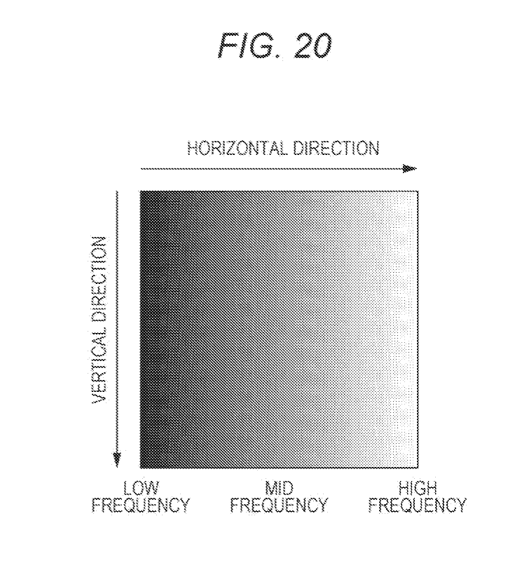

In the above described operation, the intermediate data stored in the transposition register 433 is arranged in the horizontal direction in accordance with respective frequency components, as shown in FIG. 20, for example. Specifically, low-frequency components to high-frequency components are arranged from left to right. Lower-frequency components are located in portions closer to the left edge, and higher-frequency components are located in portions closer to the right edge. In each one column (vertical line), components of the same frequency band are aligned.

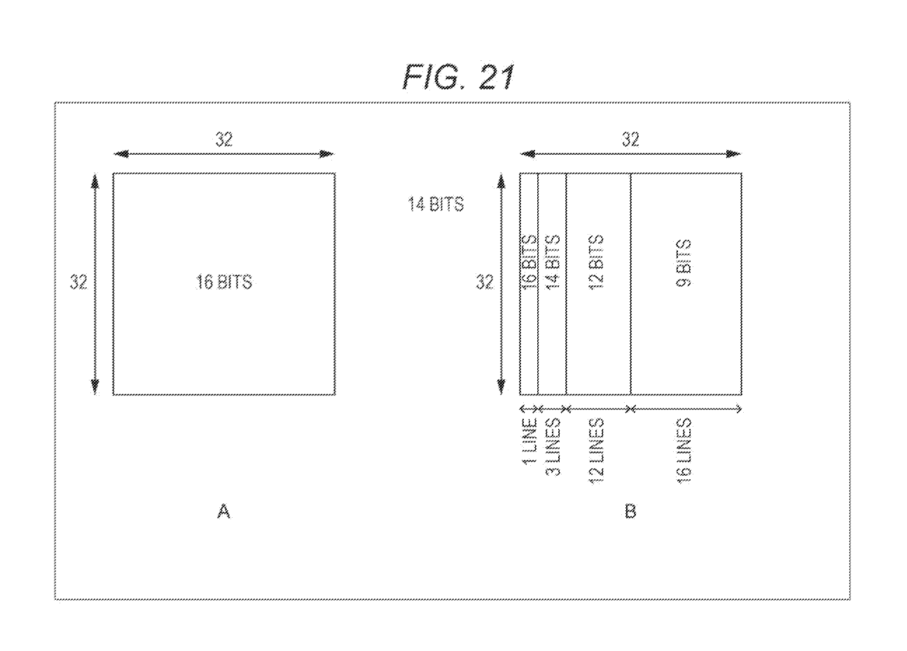

For example, the bit width of the intermediate data obtained as a result of an orthogonal transform performed by the horizontal one-dimensional transform unit 431 may be 16 bits, as shown in A of FIG. 21. Where a processing unit region is 32×32, the data amount is (32×32) 16 bits=16,384 bits.

The bit width processing unit 432 adjusts the bit width of each piece of the intermediate data for each frequency component, for example, as shown in B of FIG. 21. More specifically, the bit width processing unit 432 restricts the bit width of each piece of the intermediate data so that a low-frequency component has a greater bit width, and a high-frequency component has a smaller bit width. In B of FIG. 21, for example, the bit width processing unit 432 restricts the bit width of the intermediate data of the first column (one vertical line) from the left to 16 bits, and restricts the bit width of the intermediate data of each of the three columns (three vertical lines) of the second through fourth columns from the left to 14 bits. Also, in B of FIG. 21, the bit width processing unit 432 restricts the bit width of the intermediate data of each of the 12 columns (12 vertical lines) of the fifth through 16th columns from the left to 12 bits, and restricts the bit width of the intermediate data of each of the 16 columns (16 vertical lines) of the 17th through 32nd columns from the left to nine bits, for example.

With this arrangement, the data amount becomes (32×1)×16 bits+(32×3)×14 bits+(32×12)×12 bits+(32×16)×9 bits=11,072 bits. Accordingly, the memory usage by the transposition register 433 can be made smaller than in the above described case where the bit width of all the intermediate data is 16 bits by 5,312 bits.

It should be noted that each pixel of image data and intermediate data may have any bit width, and may have a bit width other than the examples shown in B of FIG. 21. For example, the bit widths may be reduced four columns (four vertical lines) at a time from the left. Also, the bit width of the intermediate data from the left to the 16th column (16 vertical lines) may be made the same as the bit width of the image data, and the bit width of each of the remaining 16 columns (16 vertical lines) may be made smaller than the bit width of the image data, for example.

Specifically, the bit width processing unit 432 controls the bit widths of the intermediate data in accordance with the respective frequency bands. For example, the bit width processing unit 432 reduces the bit width of the intermediate data of each horizontal line obtained by performing a horizontal one-dimensional orthogonal transform on the image data of a processing unit region, in accordance with the frequency band.

For example, the bit width processing unit 432 reduces the bit width of the intermediate data of each horizontal line of a higher-frequency component by a larger amount. In general, a natural image has a larger absolute value with respect to a lower-frequency component, and has a smaller absolute value with respect to a higher-frequency component. Accordingly, by controlling the bit widths in the above described manner, the bit width processing unit 432 can reduce the size of the transposition register 433 to be used in the orthogonal transform operation while preventing image quality deterioration.

For example, the bit width processing unit 432 reduces the bit widths of the respective pieces of intermediate data of the respective horizontal lines in accordance with the frequency characteristics of the image data. By controlling the bit widths in this manner, the bit width processing unit 432 can prevent image quality deterioration more effectively.

As the size of the transposition register 433 is reduced, the memory capacity required in an image encoding operation can be reduced, and the production costs for the image encoding device 400 can also be lowered.

There might be cases where intermediate data has errors due to a clip operation performed by the bit width processing unit 432. However, the influence of the errors can be reduced by securing sufficient bit widths to be clipped. In other words, the image encoding device 400 can control the degree of image quality deterioration and the size of the transposition register 433 by setting bit widths to be clipped. In view of this, it is desirable to set the bit widths to be clipped in accordance with the contents of the image so that the contents are optimized, for example.

[Encoding Operation Flow]

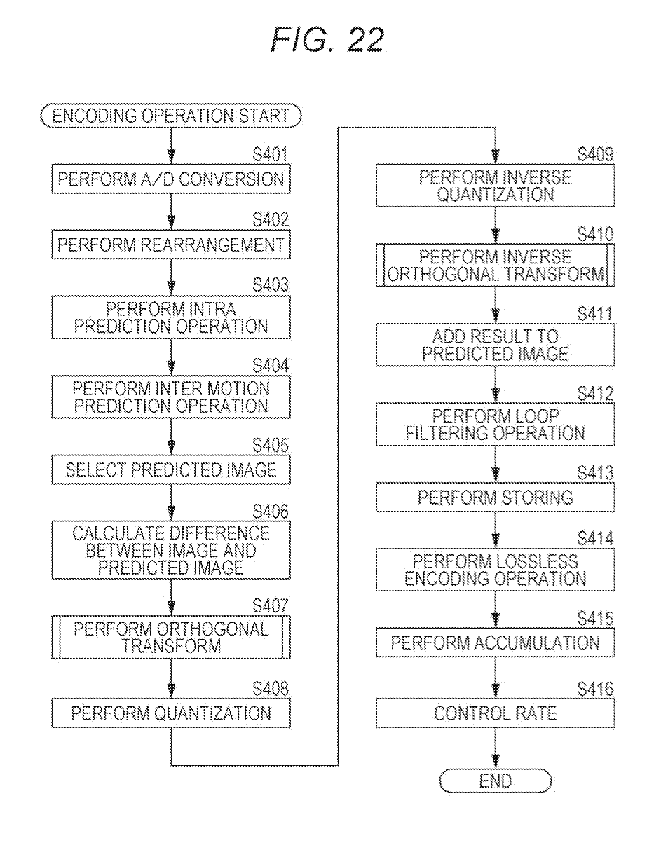

Next, the flow in each operation to be performed by the above described image encoding device 400 is described. Referring first to the flowchart shown in FIG. 22, an example flow in an encoding operation is described.

In step S401, the A/D converter 401 performs an A/D conversion on an input image. In step S402, the screen rearrangement buffer 402 stores the image subjected to the A/D conversion, and rearranges the respective pictures in encoding order, instead of displaying order.

In step S403, the intra prediction unit 414 performs intra prediction operations in intra prediction modes. In step S404, the motion prediction/compensation unit 415 performs inter motion prediction operations to perform motion predictions and motion compensation in inter prediction modes.

In step S405, the predicted image selection unit 416 determines an optimum mode based on the respective cost function values that are output from the intra prediction unit 414 and the motion prediction/compensation unit 415. That is, the predicted image selection unit 416 selects the predicted image generated by the intra prediction unit 414 or the predicted image generated by the motion prediction/compensation unit 415.

In step S406, the arithmetic operation unit 403 calculates the difference between the image rearranged in the procedure of step S402 and the predicted image selected in the procedure of step S405. The data amount of the difference data is smaller than that of the original image data. Accordingly, the data amount can be made smaller than in a case where an image is directly encoded.

In step S407, the orthogonal transform unit 404 performs an orthogonal transform on the difference information generated in the procedure of step S406. Specifically, an orthogonal transform such as a discrete cosine transform or a Karhunen-Loeve transform is performed, and a transform coefficient is output.

In step S408, the quantization unit 405 quantizes the orthogonal transform coefficient obtained in the procedure of step S407.

The difference information quantized in the procedure of step S408 is locally decoded in the following manner. In step S409, the inverse quantization unit 408 inversely quantizes the quantized orthogonal transform coefficient (also referred to as the quantized coefficient) generated in the procedure of step S408, using properties compatible with the properties of the quantization unit 405.

In step S410, the inverse orthogonal transform unit 409 performs an inverse orthogonal transform on the orthogonal transform coefficient obtained in the procedure of step S407, using properties compatible with the properties of the orthogonal transform unit 404. This inverse orthogonal transform operation is performed in the same manner as in the above described first through third embodiments, and therefore, specific explanation of the operation is not repeated herein.

In step S411, the arithmetic operation unit 410 adds the predicted image to the locally decoded difference information, and generates a locally decoded image (an image corresponding to the input to the arithmetic operation unit 403). In step S412, the loop filter 411 performs a loop filtering operation including a deblocking filtering operation and an adaptive loop filtering operation on the locally decoded image obtained in the procedure of step S411, where appropriate.

In step S413, the frame memory 412 stores the decoded image subjected to the loop filtering operation in the procedure of step S412. The image that has not been subjected to the filtering operation by the loop filter 411 is also supplied from the arithmetic operation unit 410, and is stored into the frame memory 412.

In step S414, the lossless encoding unit 406 encodes the transform coefficient quantized in the procedure of step S408. That is, lossless encoding such as variable-length encoding or arithmetic encoding is performed on the difference image.

The lossless encoding unit 406 also encodes the quantization parameter calculated in step S408, and adds the encoded quantization parameter to the encoded data. The lossless encoding unit 406 also encodes the information about the prediction mode of the predicted image selected in the procedure of step S405, and adds the encoded information to the encoded data obtained by encoding the difference image. That is, the lossless encoding unit 406 also encodes information in accordance with the optimum intra prediction mode information supplied from the intra prediction unit 414 or the optimum inter prediction mode supplied from the motion prediction/compensation unit 415, and adds the encoded information to the encoded data.

In step S415, the accumulation buffer 407 accumulates the encoded data obtained in the procedure of step S414. The encoded data accumulated in the accumulation buffer 407 is read where appropriate, and is transmitted to the decoding side via a transmission path or a recording medium.

In step S416, based on the bit rate (bit generation rate) of the encoded data that is accumulated in the accumulation buffer 407 in the procedure of step S415, the rate control unit 417 controls the quantization operation rate of the quantization unit 405 so as not to cause an overflow or underfloor.

When the procedure of step S416 is completed, the encoding operation comes to an end.

[Flow in the Orthogonal Transform Operation]

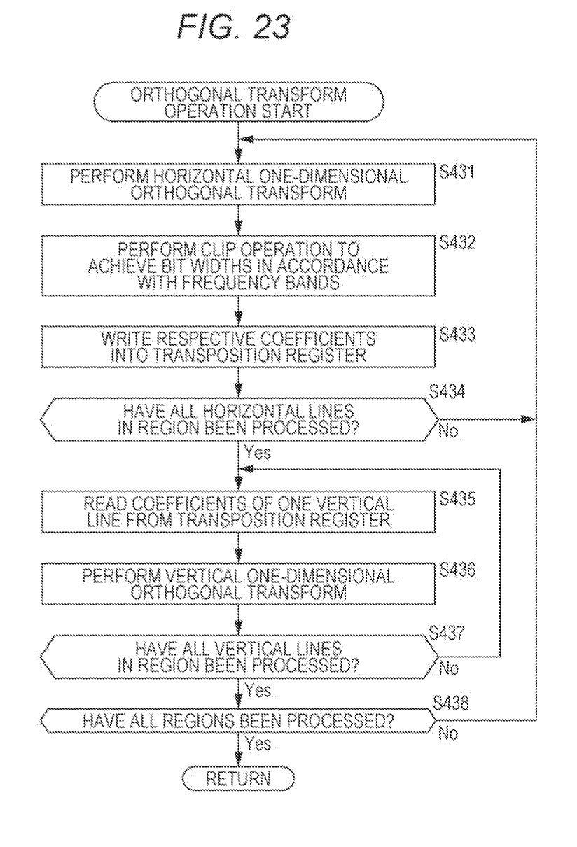

Referring now to the flowchart shown in FIG. 23, an example flow in the orthogonal transform operation to be performed in step S407 of FIG. 22 is described.

In step S431, the horizontal one-dimensional transform unit 431 performs a horizontal one-dimensional orthogonal transform on the image data of one horizontal line in the current region.

In step S432, the bit width processing unit 432 performs a clip operation on the intermediate data of the one horizontal line obtained in the procedure of step S431, to achieve a bit width in accordance with the frequency band.

As described above with reference to FIG. 20, the frequency components of the intermediate data of the respective pixels vary from a low frequency band to a high frequency band in the horizontal direction. That is, the intermediate data of one horizontal line contains components of low to high frequencies. Accordingly, the bit width processing unit 432 performs a clip operation on each piece of intermediate data of one horizontal line with bit widths in accordance with the respective frequency components. Specifically, the intermediate data of one horizontal line is classified according to frequency bands, and is subjected to a clip operation with different bit widths in the respective bands. In a case where respective pieces of intermediate data are different frequency components from one another, for example, the respective pieces of intermediate data are subjected to a clip operation with different bit widths from one another. In the case of the above described inverse orthogonal transform, frequency distribution appears in the vertical direction, and accordingly, respective pieces of intermediate data of one horizontal line is subjected to a clip operation with the same bit width. In the case of the orthogonal transform, however, the respective pieces of intermediate data of one horizontal line might have different bit widths from one another as a result of such a clip operation.

In step S433, the bit width processing unit 432 writes the intermediate data of the one horizontal line subjected to the clip operation into the row located one row below the previously written intermediate data of one horizontal line in the transposition register 433.

In step S434, the horizontal one-dimensional transform unit 431 determines whether all the horizontal lines in the region have been processed. When it is determined that there is a horizontal line yet to be processed in the current region, the operation returns to step S431, and the procedures thereafter are carried out.

For the respective horizontal lines, the procedures of steps S431 through S434 are repeated. When it is determined in step S434 that all the horizontal lines in the current region have been processed, the horizontal one-dimensional transform unit 431 moves the operation to step S435.

The vertical one-dimensional transform unit 434 reads the intermediate data of one vertical line from the transposition register 433 in step S435, and performs a vertical one-dimensional orthogonal transform on the read intermediate data in step S436.

In step S437, the vertical one-dimensional transform unit 434 determines whether all the vertical lines in the region have been processed. When it is determined that there is a vertical line yet to be processed in the current region, the operation returns to step S435, and the procedures thereafter are carried out.

For the respective vertical lines, the procedures of steps S435 through S437 are repeated. When it is determined in step S437 that all the vertical lines in the current region have been processed, the vertical one-dimensional transform unit 434 moves the operation to step S438.

In step S438, the vertical one-dimensional transform unit 434 determines whether all the regions in the image have been processed. When it is determined that there is a region yet to be processed, the operation returns to step S431, and the procedures thereafter are repeated.

If it is determined in step S438 that all the regions have been processed after the procedures of steps S431 through S438 have been repeated for the respective regions in the above described manner, the vertical one-dimensional transform unit 434 ends the orthogonal transform operation, and returns the operation to FIG. 22.

By carrying out the respective procedures in the above manner, the image encoding device 400 can reduce the data amount of intermediate data obtained in the orthogonal transform operation, and can reduce the size of the storage area used as the transposition register 433. As a result of this, the memory capacity required in the image encoding operation can be reduced, and the production costs for the image encoding device 400 can be lowered.

### 5. Fifth Embodiment

### [Orthogonal Transform Unit]

In the case of the orthogonal transform unit 404, to reduce the value of each piece of intermediate data, a predetermined row (a horizontal line) of coefficient data subjected to a horizontal orthogonal transform may be set as a reference, and difference values with respect to the reference may be stored as the intermediate data into the transposition register 433, as in the inverse orthogonal transform unit 104. Specifically, the differences between the same frequency components among the results of a horizontal one-dimensional transform may be calculated, and the differences may be set as the intermediate data.

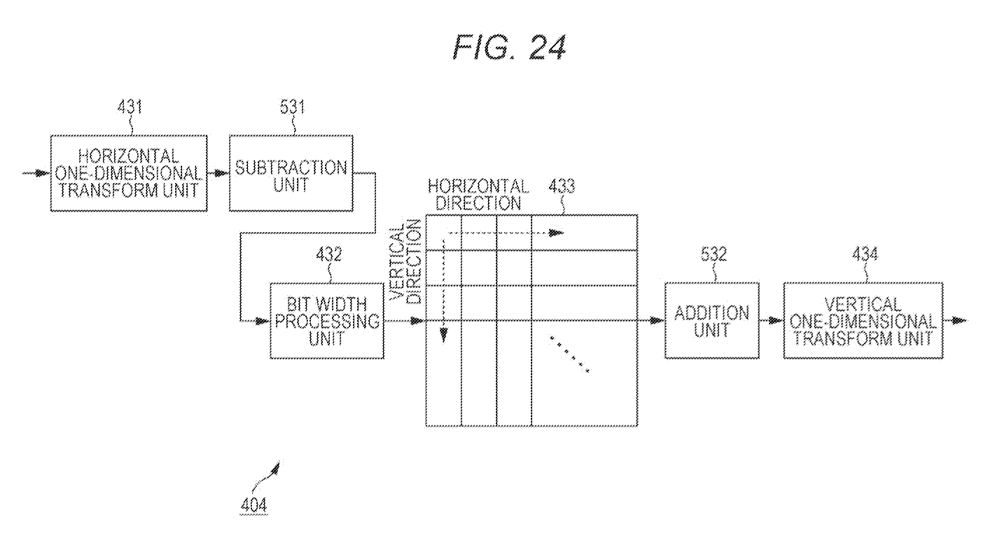

FIG. 24 is a block diagram showing an example structure of the orthogonal transform unit 404 in this case. As shown in FIG. 24, the orthogonal transform unit 404 in this case includes not only the components described above with reference to FIG. 19, but also a subtraction unit 531 between the horizontal one-dimensional transform unit 431 and the bit width processing unit 432, and an addition unit 532 between the transposition register 433 and the vertical one-dimensional transform unit 434.

The subtraction unit 531 sets reference pixels that are the pixels on a predetermined horizontal line among respective coefficients arranged in a matrix (an array) as described above, and calculates the difference values between the coefficients of the reference pixels and the coefficients of the respective pixels other than the reference pixels in the respective vertical lines.

The bit width processing unit 432 performs a clip operation on the difference values output from the subtraction unit 531. For example, the bit width processing unit 432 reduces the bit width of each of the supplied difference values to a predetermined bit width, and supplies the bit widths to the transposition register 433, which then stores the bit widths as intermediate data. Also, the bit width processing unit 432 supplies the coefficients of the respective reference pixels to the transposition register 433 as they are, and the coefficients are stored as intermediate data, without a reduction in bit width.

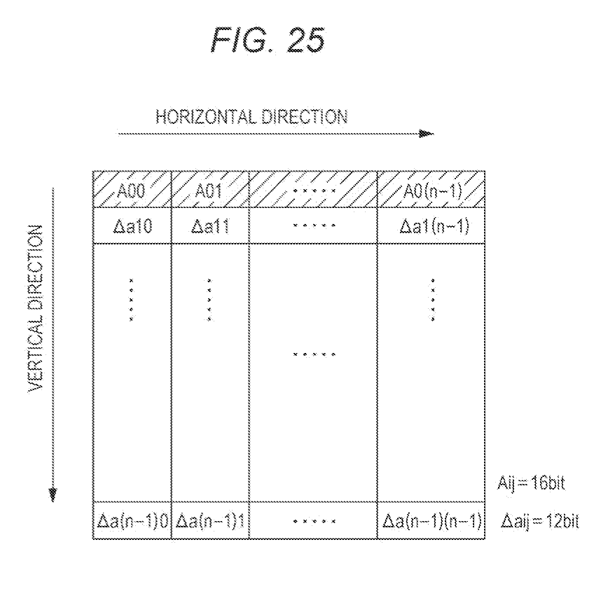

FIG. 25 is a diagram showing an example of intermediate data stored in the transposition register 433.

In the example case illustrated in FIG. 25, the size of each processing unit region in an orthogonal transform operation is n×n pixels. The bit width of an output Aᵢⱼ (0≦i<n, 0≦j<n) of the horizontal one-dimensional transform unit 431 is 16 bits.

The subtraction unit 531 sets the uppermost row (i=0) as the reference pixel line with respect to such an output, and calculates the difference values Δaᵢⱼ between the coefficients of the other rows (0<i<n−1) and the coefficients of the reference pixels, as shown in the following equations (8) and (9).

Δaᵢⱼ=ABS(Aᵢⱼ)−ABS(A₀ᵢ)(0<i<n,0≦j<n) (8)

Bᵢⱼ=MBS(Aᵢⱼ)(0<i<n,0≦j<n) (9)

Here, Bᵢⱼ represents the sign bit of Aᵢⱼ.

That is, the subtraction unit 531 stores the respective coefficients of the horizontal line to be first processed in the region as the reference pixels, and calculates the difference values between the respective pixels of each horizontal line that is processed second or later and the reference pixel located in the same vertical line as the pixels. The subtraction unit 531 sets intermediate data formed with the difference values Δaᵢⱼ calculated in the above described manner with respect to the pixels (0<i<n, 0≦j<n) other than the reference pixels, and the sign bits Bᵢⱼ, and supplies the intermediate data to the bit width processing unit 432. The subtraction unit 531 also sets intermediate data formed with 16-bit coefficients Aᵢⱼ with respect to the reference pixel line (I=0, 0≦j<n), and supplies the intermediate data to the bit width processing unit 432.

As described above with reference to FIG. 20, the coefficients subjected to a horizontal one-dimensional transform have respective frequency components distributed in the horizontal direction. That is, the same frequency components are aligned in the vertical direction, and correlate highly with one another. Taking advantage of the high correlations in the vertical direction, the subtraction unit 531 calculates the differences between the coefficients aligned in the vertical direction as described above, and reduces the value of each piece of intermediate data. If subtractions with signs are performed at this point, the values might become even larger. Therefore, the subtraction unit 531 calculates the differences between the absolute values of the respective coefficients as shown in the equation (8). By doing so, the subtraction unit 531 can reduce the values of intermediate data with a higher degree of certainty.

That is, there is a high possibility that Δaᵢⱼ (0<i<n, 0≦j<n) can be expressed with smaller bit widths than Aᵢⱼ (i=0, 0≦j<n). In view of this, the bit width processing unit 432 performs a clip operation on each of the supplied difference values with a smaller bit width than the original 16 bits. In the example illustrated in FIG. 25, the clip operation is performed with 12 bits. The bit width processing unit 432 reduces the difference values to a predetermined bit width, and supplies and stores the bit width into the transposition register 433.

By doing so, the orthogonal transform unit 404 can reduce the size of the transposition register 433 by a larger amount than in a case where all the intermediate data is stored while the bit width remains 16 bits.

As for the reference pixels, the bit width processing unit 432 transmits and stores the coefficients Aᵢⱼ (i=0, 0<j<n) as intermediate data into the transposition register 433. In the example case illustrated in FIG. 25, to prevent image quality deterioration, the bit width processing unit 432 stores the intermediate data Aᵢⱼ (i=0, 0<j<n) into the transposition register 433 (the shaded portion) while the bit width remains 16 bits. If some image quality deterioration is allowed, the intermediate data Aᵢⱼ (i=0, 0<j<n) may also be subjected to a clip operation to reduce bit widths at the bit width processing unit 432.

The addition unit 532 reads the intermediate data from the transposition register 433 one vertical line at a time. As shown in FIG. 25, each vertical line includes not only the intermediate data of difference value, but also the intermediate data of the reference pixels used in calculating the difference values. The addition unit 532 adds the intermediate data of the reference pixels included in one read vertical line to the respective difference values included in the vertical line, as shown in the following equation (10).

ABS(Aᵢⱼ)=ABS(A₀ⱼ)+Δaᵢⱼ(0<i<n,0≦j<n) (10)

The addition unit 532 adds the sign bit Bᵢⱼ to the absolute values of Aᵢⱼ calculated as above. As a result, the respective pieces of the intermediate data of the vertical lines other than the reference pixel line are restored. The addition unit 532 supplies the intermediate data restored in the above manner to the vertical one-dimensional transform unit 434. The addition unit 532 also supplies the intermediate data of the reference pixels included in the vertical line read from the transposition register 433, to the vertical one-dimensional transform unit 434. Since the intermediate data of the reference pixels is not difference values, the read intermediate data of the reference pixels is supplied to the vertical one-dimensional transform unit 434 as it is.

The vertical one-dimensional transform unit 434 performs a vertical one-dimensional orthogonal transform operation on the intermediate data supplied as above, and generates orthogonal transform coefficient data by subjecting the image data to an orthogonal transform in two dimensions (the horizontal direction and the vertical direction). In a case where a clip operation is performed on the intermediate data as described above, there is a possibility that errors are caused by the clip operation. Therefore, the restored image data might not be completely in the same state as it was before the orthogonal transform operation, even if the coefficient data is subjected to an inverse orthogonal transform. However, image quality deterioration due to the errors is not large. In other words, the bit widths to be subjected to the clip operation should be defined so that the image quality deterioration falls within an allowable range.

In the case of an orthogonal transform, all the vertical lines include a reference pixel as described above. Accordingly, any row may be set as the reference pixel line.

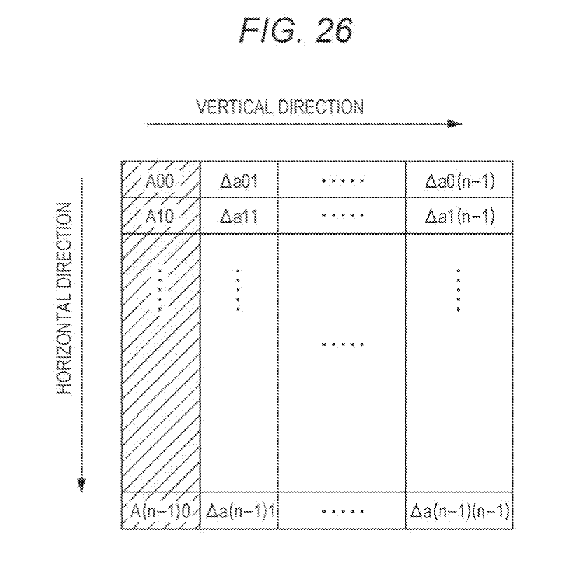

The intermediate data of the region to be processed next is written, with the horizontal direction and the vertical direction (or the rows and the columns) being transposed as shown in FIG. 26. However, the reading of the intermediate data is performed in each horizontal line, with the horizontal direction and the vertical direction being also transposed in this case. Accordingly, the reference pixel column (vertical line) can be any line.

As for the intermediate data of the region after the next, the horizontal direction and the vertical direction are again transposed, and the intermediate data of the region after the next is stored as shown in FIG. 25.

[Flow in the Orthogonal Transform Operation]

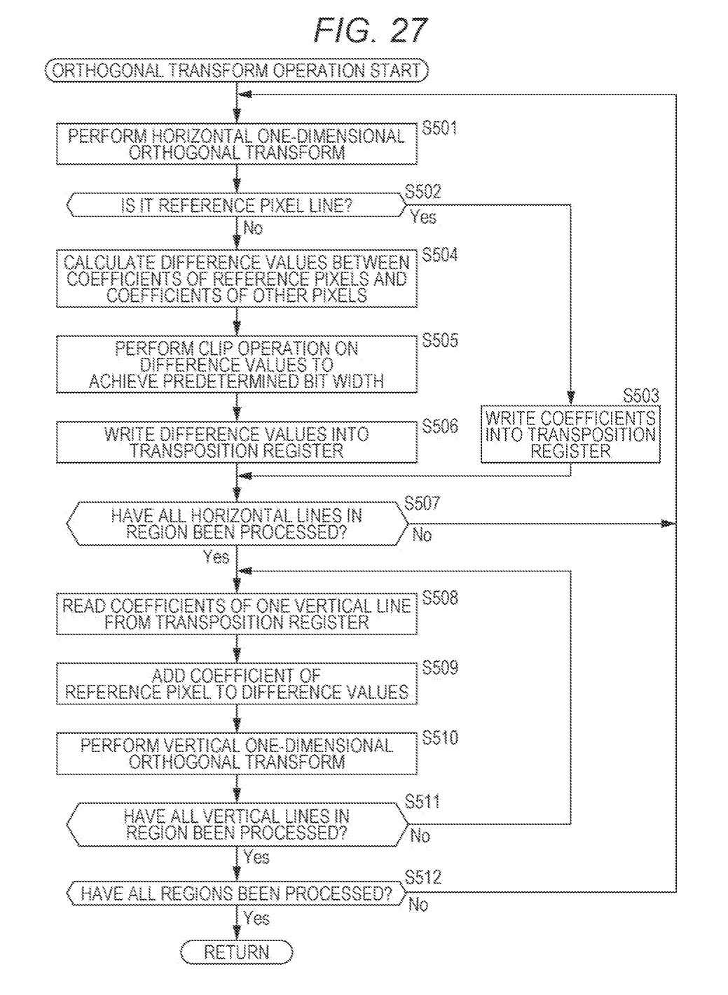

Referring now to the flowchart in FIG. 27, an example flow in the orthogonal transform operation in this case is described.

In step S501, the horizontal one-dimensional transform unit 431 performs a horizontal one-dimensional orthogonal transform on the image data of the current horizontal line. In step S502, the subtraction unit 531 determines whether the current horizontal line is the reference pixel line. If the current horizontal line is determined to be the reference pixel line, the subtraction unit 531 moves the operation to step S503.

In step S503, the bit width processing unit 432 writes the coefficients of the horizontal line into the transposition register 433. The subtraction unit 531 also holds the respective coefficients of this horizontal line. When the procedure of step S503 is completed, the bit width processing unit 432 moves the operation to step S507.

If the current horizontal line is determined not to be the reference pixel line in step S502, the subtraction unit 531 moves the operation to step S504. In step S504, the subtraction unit 531 calculates difference values by subtracting the coefficients of the reference pixels located in the same positions in the horizontal direction as the respective coefficients of the horizontal line, from the respective coefficients of the horizontal line.

In step S505, the bit width processing unit 432 performs a clip operation on each of the difference values, so as to reduce the bit widths to a predetermined bit width. In step S506, the bit width processing unit 432 supplies and stores the respective difference values having the reduced bit width as the intermediate data into the transposition register 433. When the procedure of step S506 is completed, the bit width processing unit 432 moves the operation to step S507.

In step S507, the horizontal one-dimensional transform unit 431 determines whether all the horizontal lines in the region have been processed. When it is determined that there is a horizontal line yet to be processed, the operation returns to step S501, and the procedures thereafter are repeated. For the respective horizontal lines in the region, the procedures of steps S501 through S507 are repeated. When it is determined in step S507 that all the horizontal lines in the region have been processed, the horizontal one-dimensional transform unit 431 moves the operation to step S508.

In step S508, the addition unit 532 reads the intermediate data from the transposition register 433 one vertical line at a time. In step S508, the addition unit 532 adds the coefficient of the reference pixel to each of the difference values in a read vertical line.

In step S510, the vertical one-dimensional transform unit 434 performs a vertical one-dimensional orthogonal transform on the respective coefficients of the vertical line, and generates coefficient data subjected to a orthogonal transform in two dimensions.

In step S511, the vertical one-dimensional transform unit 434 determines whether all the vertical lines in the region have been processed. When it is determined that there is a vertical line yet to be processed, the operation returns to step S508, and the procedures thereafter are repeated. For the respective vertical lines, the procedures of steps S508 through S511 are repeated. When it is determined in step S511 that all the vertical lines in the region have been processed, the vertical one-dimensional transform unit 434 moves the operation to step S512.

In step S512, the vertical one-dimensional transform unit 434 determines whether all the regions in the image have been processed. When it is determined that there is a region yet to be processed, the operation returns to step S501, and the procedures thereafter are repeated.

If it is determined in step S512 that all the regions have been processed after the procedures of steps S501 through S512 have been repeated for the respective regions in the above described manner, the vertical one-dimensional transform unit 434 ends the orthogonal transform operation, and returns the operation to FIG. 22.

By carrying out the respective procedures in the above manner, the image encoding device 400 can reduce the data amount of intermediate data obtained in the orthogonal transform operation, and can reduce the size of the storage area used as the transposition register 433. As a result of this, the memory capacity required in the image encoding operation can be reduced, and the production costs for the image encoding device 400 can be lowered.

[Another Example Flow in the Orthogonal Transform Operation]

In the above description, the bit width processing unit 432 performs a clip operation to adjust all the difference values to the same bit width. However, in the case of difference values calculated in the above described manner, the frequency distribution is the same as that shown in FIG. 20, as in the fourth embodiment. Therefore, the bit width processing unit 432 may control the bit widths of the respective pieces of intermediate data (difference values) in accordance with frequency bands, as in the fourth embodiment.

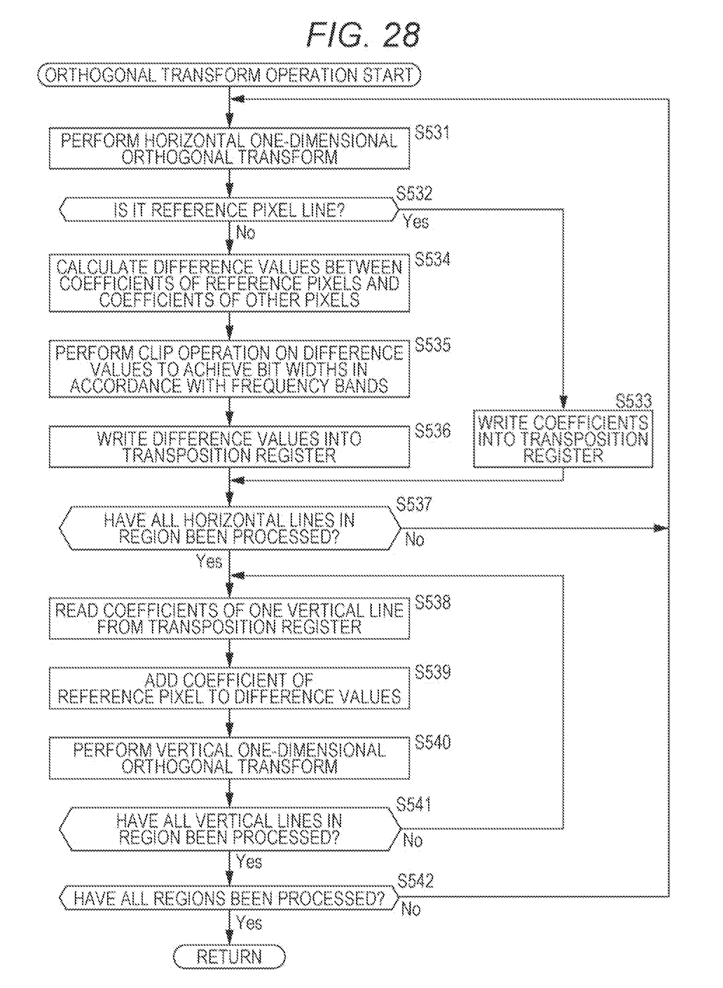

Referring now to the flowchart in FIG. 28, an example flow in the orthogonal transform operation in this case is described.

The flow in the orthogonal transform operation in this case is basically the same as that described above with reference to the flowchart in FIG. 27. Specifically, the respective procedures of steps S531 through S542 are carried out in the same manner as the respective procedures of steps S501 through S512 of FIG. 27.

In step S535, however, the bit width processing unit 432 performs a clip operation on difference values to reduce bit widths in accordance with the frequency bands. The bit width processing unit 432 also performs a clip operation on the intermediate data of the reference pixels to reduce the bit widths in accordance with the frequency bands in the same manner.

By doing so, the orthogonal transform unit 404 can reduce the size of the transposition register 433 while preventing image quality deterioration more effectively than in the case shown in FIG. 27.

In each of the above described embodiments, orthogonal transform operations and inverse orthogonal transform operations are performed in both the horizontal direction and the vertical direction. In those operations, however, any transform methods can be used, and any orthogonal transform method and any inverse orthogonal transform method may be used for each operation in the horizontal direction and for each operation in the vertical direction. For example, it is possible to perform DCTs, Karhunen-Loeve transforms, or DSTs. Also, different transform methods may be adopted between the horizontal direction and the vertical direction. For example, DCTs (IDCTs) may be performed in the horizontal direction, and DSTs (IDSTs) may be performed in the vertical direction. In the example case illustrated in FIG. 4, the horizontal one-dimensional inverse transform unit 131 may perform IDCTs, and the vertical one-dimensional inverse transform unit 134 may perform IDSTs. The horizontal one-dimensional inverse transform unit 131 may of course perform IDSTs, and the vertical one-dimensional inverse transform unit 134 may perform IDCTs. The horizontal one-dimensional inverse transform unit 131 and the vertical one-dimensional inverse transform unit 134 may adopt methods other than IDCTs and IDSTs. The same applies to the other embodiments. The same applies to the orthogonal transform unit 404 and the inverse orthogonal transform unit 409 of the image encoding device 400.

The present technique can be applied to image encoding devices and image decoding devices that are used when image information (bit streams) encoded through orthogonal transforms such as discrete cosine transforms is received via a network medium such as satellite broadcasting, cable television, the Internet, or a portable telephone device, as in MPEG or H.26x, for example. The present technique can also be applied to image encoding devices and image decoding devices that are used when compressed image information is processed on a storage medium such as an optical or magnetic disk or a flash memory. Further, the present technique can also be applied to orthogonal transform devices and inverse orthogonal transform devices included in such image encoding devices and image decoding devices.

### 6. Sixth Embodiment

### [Personal Computer]

The above described series of operations can be performed by hardware, and can also be performed by software. When the series of operations are to be performed by software, the programs forming the software are installed in a computer. Here, the computer may be a computer incorporated into special-purpose hardware, or may be a general-purpose personal computer that can execute various kinds of functions as various kinds of programs are installed thereinto.

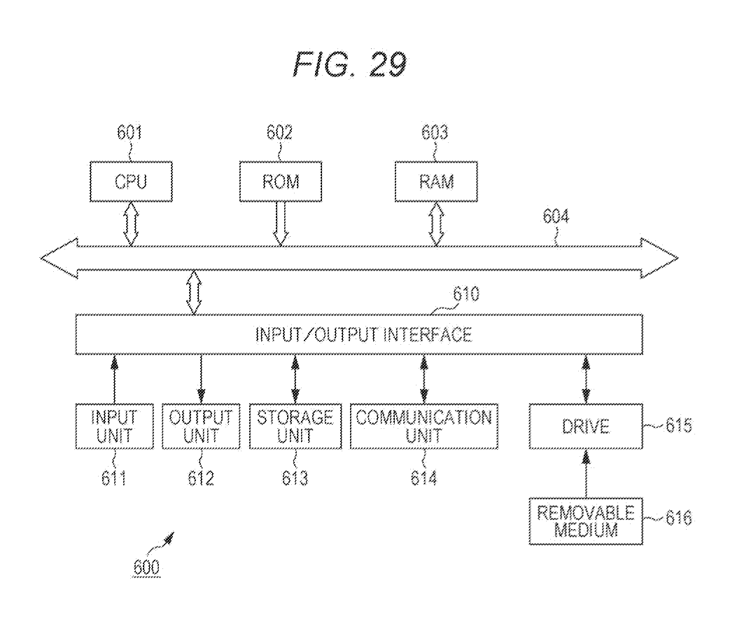

In FIG. 29, the CPU (Central Processing Unit) 601 of the personal computer 600 performs various kinds of operations in accordance with a program stored in a ROM (Read Only Memory) 602 or a program loaded into a RAM (Random Access Memory) 603 from a storage unit 613. Necessary data for the CPU 601 to perform various kinds of operations and the like are also stored in the RAM 603, where necessary.

The CPU 601, the ROM 602, and the RAM 603 are connected to one another via a bus 604. An input/output interface 610 is also connected to the bus 604.

The input/output interface 610 has the following components connected thereto: an input unit 611 formed with a keyboard, a mouse, or the like; an output unit 612 formed with a display such as a CRT (Cathode Ray Tube) or a LCD (Liquid Crystal Display), and a speaker; the storage unit 613 formed with a hard disk or the like; and a communication unit 614 formed with a modem. The communication unit 614 performs communications via networks including the Internet.

A drive 615 is also connected to the input/output interface 610 where necessary, and a removable medium 616 such as a magnetic disk, an optical disk, a magnetooptical disk, or a semiconductor memory is mounted on the drive as appropriate. A computer program read from such a removable disk is installed into the storage unit 613 where necessary.

In a case where the above described series of operations is performed by software, the program forming the software is installed from a network or a recording medium.

As shown in FIG. 29, this recording medium is formed with the removable medium 616 that is distributed for delivering the program to users separately from the device, such as a magnetic disk (including a flexible disk), an optical disk (including a CD-ROM (Compact Disc-Read Only Memory) or a DVD (Digital Versatile Disc)), a magnetooptical disk (including an MD (Mini Disc)), or a semiconductor memory, which has the program recorded thereon. Alternatively, the recording medium may be formed with the ROM 602 having the program recorded therein or a hard disk included in the storage unit 613. Such a recording medium is incorporated beforehand into the device prior to the delivery to users.

The programs to be executed by the computer may be programs for performing operations in chronological order in accordance with the sequence described in this specification, or may be programs for performing operations in parallel or performing an operation when necessary, such as when there is a call.

In this specification, the step of writing a program to be recorded on a recording medium includes not only operations to be performed in chronological order in accordance with the disclosed sequences, but also operations to be performed in parallel or independently of one another if not necessarily in chronological order.

In this specification, a “system” means an entire apparatus formed with two or more devices (apparatuses).

Also, in the above described examples, any structure described as one device (or one processing unit) may be divided into two or more devices (or processing units). Conversely, any structure described as two or more devices (or processing units) may be combined to form one device (or one processing unit). Also, it is of course possible to add a structure other than the above described ones to the structure of any of the devices (or any of the processing units). Further, as long as the structure and function of the entire system remain the same, part of the structure of a device (or a processing unit) may be incorporated into another device (or another processing unit). That is, embodiments of the present technique are not limited to the above described embodiments, and various modifications may be made to them without departing from the scope of the technique.

The image encoding device and the image decoding device according to the above described embodiments can be applied to various electronic apparatuses including: transmitters and receivers for satellite broadcasting, cable broadcasting such as cable television, deliveries via the Internet, deliveries to terminals by cellular communications, and the like; recording apparatuses that record images on media such as optical disks, magnetic disks, or flash memories; or reproducing apparatuses that reproduce images from those storage media. In the following, four example applications are described.

### 7. Seventh Embodiment

### [First Example Application: Television Receiver]

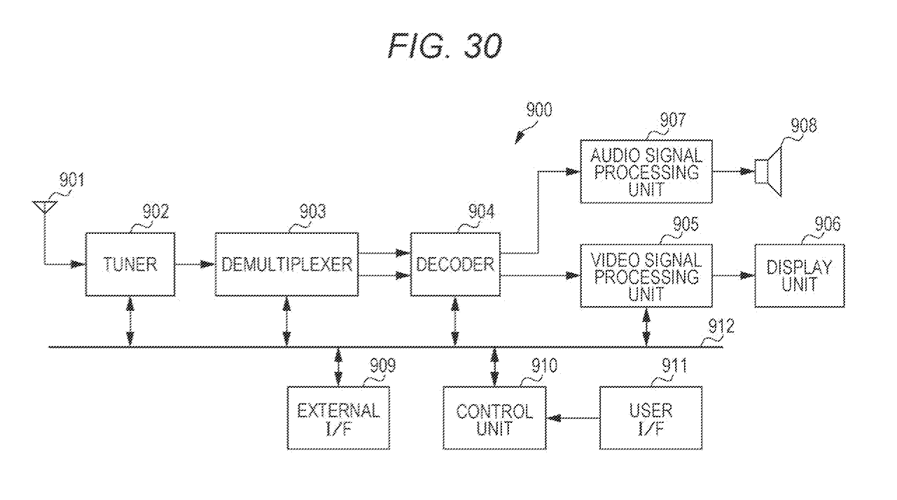

FIG. 30 schematically shows an example structure of a television apparatus to which the above described embodiments are applied. The television apparatus 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal of a desired channel from broadcast signals received via the antenna 901, and demodulates the extracted signal. The tuner 902 outputs the encoded bit stream obtained by the demodulation to the demultiplexer 903. That is, the tuner 902 serves as a transmission means in the television apparatus 900 that receives encoded streams formed by encoding images.

The demultiplexer 903 separates the video stream and the audio stream of a show to be viewed from the encoded bit stream, and outputs the respective separated streams to the decoder 904. The demultiplexer 903 also extracts auxiliary data such as an EPG (Electronic Program Guide) from the encoded bit stream, and supplies the extracted data to the control unit 910. In a case where the encoded bit stream has been scrambled, the demultiplexer 903 may perform descrambling.

The decoder 904 decodes the video stream and the audio stream input from the demultiplexer 903. The decoder 904 then outputs the video data generated by the decoding operation to the video signal processing unit 905. The decoder 904 also outputs the audio data generated by the decoding operation to the audio signal processing unit 907.

The video signal processing unit 905 reproduces the video data input from the decoder 904, and causes the display unit 906 to display the video image. Also, the video signal processing unit 905 may cause the display unit 906 to display an application screen supplied via a network. Also, the video signal processing unit 905 may perform additional processing such as denoising on the video data in accordance with the settings. Further, the video signal processing unit 905 may generate an image of a GUI (Graphical User Interface) such as a menu and buttons or a cursor, and superimpose the generated image on an output image.

The display unit 906 is driven by a drive signal supplied from the video signal processing unit 905, and displays a video image or an image on the video screen of a display device (such as a liquid crystal display, a plasma display, or an GELD (Organic ElectroLuminescence Display)).

The audio signal processing unit 907 performs a reproducing operation such as a D/A conversion and amplification on the audio data input from the decoder 904, and outputs sound from the speaker 908. Also, the audio signal processing unit 907 may perform additional processing such as denoising on the audio data.

The external interface 909 is an interface for connecting the television apparatus 900 to an external device or a network. For example, a video stream or an audio stream received via the external interface 909 may be decoded by the decoder 904. That is, the external interface 909 also serves as a transmission means in the television apparatus 900 that receives encoded streams formed by encoding images.

The control unit 910 includes a processor such as a CPU, and a memory such as a RAM or a ROM. The memory stores the program to be executed by the CPU, program data, EPG data, data acquired via networks, and the like. The program stored in the memory is read by the CPU at the time of activation of the television apparatus 900, for example, and is then executed. By executing the program, the CPU controls operations of the television apparatus 900 in accordance with an operating signal input from the user interface 911, for example.

The user interface 911 is connected to the control unit 910. The user interface 911 includes buttons and switches for the user to operate the television apparatus 900, and a reception unit for remote control signals, for example. The user interface 911 generates an operating signal by detecting an operation by the user via those components, and outputs the generated operating signal to the control unit 910.

The bus 912 connects the tuner 902, the demultiplexer 903, the decoder 904, the video signal processing unit 905, the audio signal processing unit 907, the external interface 909, and the control unit 910 to one another.

In the television apparatus 900 having the above described structure, the decoder 904 has the functions of the image decoding device according to the above described embodiments. Accordingly, the size of the transposition registers to be used in inverse orthogonal transform operations at the time of image decoding in the television apparatus 900 can be reduced.

### 8. Eighth Embodiment

### [Second Example Application: Portable Telephone Device]

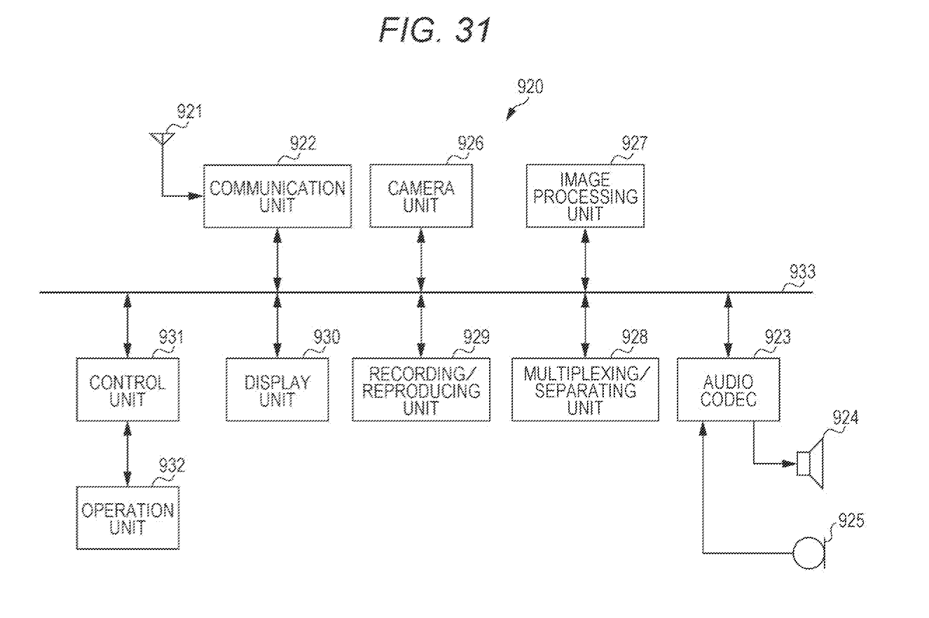

FIG. 31 schematically shows an example structure of a portable telephone device to which the above described embodiments are applied. The portable telephone device 920 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the multiplexing/separating unit 928, the recording/reproducing unit 929, the display unit 930, and the control unit 931 to one another.

The portable telephone device 920 performs operations such as transmission and reception of audio signals, transmission and reception of electronic mail or image data, imaging operations, and data recording in various operation modes including an audio communication mode, a data communication mode, an imaging mode, and a video phone mode.

In the audio communication mode, an analog audio signal generated by the microphone 925 is supplied to the audio codec 923. The audio codec 923 converts the analog audio signal to audio data, and performs compression and an A/D conversion on the converted audio data. The audio codec 923 outputs the compressed audio data to the communication unit 922. The communication unit 922 encodes and modulates the audio data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 generates audio data by demodulating and decoding the reception signal, and outputs the generated audio data to the audio codec 923. The audio codec 923 performs decompression and a D/A conversion on the audio data, to generate an analog audio signal. The audio codec 923 then outputs the generated audio signal to the speaker 924 to output sound.

In the data communication mode, the control unit 931 generates text data constituting an electronic mail in accordance with an operation by the user via the operation unit 932. The control unit 931 causes the display unit 930 to display the text. The control unit 931 also generates electronic mail data in accordance with a transmission instruction from the user via the operation unit 932, and outputs the generated electronic mail data to the communication unit 922. The communication unit 922 encodes and modulates the electronic mail data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The communication unit 922 then restores the electronic mail data by demodulating and decoding the reception signal, and outputs the restored electronic mail data to the control unit 931. The control unit 931 causes the display unit 930 to display the contents of the electronic mail, and stores the electronic mail data into the storage medium in the recording/reproducing unit 929.

The recording/reproducing unit 929 includes a readable/rewritable storage medium. For example, the storage medium may be an internal storage medium such as a RAM or a flash memory, or may be a storage medium of an externally mounted type such as a hard disk, a magnetic disk, a magnetooptical disk, an optical disk, a USB (Unallocated Space Bitmap) memory, or a memory card.

In the imaging mode, the camera unit 926 generates image data by capturing an image of an object, and outputs the generated image data to the image processing unit 927. The image processing unit 927 encodes the image data input from the camera unit 926, and stores the encoded stream into the storage medium in the recording/reproducing unit 929.

In the video phone mode, the multiplexing/separating unit 928 multiplexes a video stream encoded by the image processing unit 927 and an audio stream input from the audio codec 923, and outputs the multiplexed stream to the communication unit 922. The communication unit 922 encodes and modulates the stream, to generate a transmission signal. The communication unit 922 transmits the generated transmission signal to a base station (not shown) via the antenna 921. The communication unit 922 also performs amplification and a frequency conversion on a radio signal received via the antenna 921, and obtains a reception signal. The transmission signal and the reception signal each include an encoded bit stream. The communication unit 922 restores a stream by demodulating and decoding the reception signal, and outputs the restored stream to the multiplexing/separating unit 928. The multiplexing/separating unit 928 separates the video stream and the audio stream from the input stream, and outputs the video stream to the image processing unit 927 and the audio stream to the audio codec 923. The image processing unit 927 decodes the video stream, to generate video data. The video data is supplied to the display unit 930, and a series of images are displayed by the display unit 930. The audio codec 923 performs decompression and a D/A conversion on the audio stream, to generate an analog audio signal. The audio codec 923 then outputs the generated audio signal to the speaker 924 to output sound.

In the portable telephone device 920 having the above described structure, the image processing unit 927 has the functions of the image encoding device and the image decoding device according to the above described embodiments. Accordingly, the size of the transposition registers to be used in orthogonal transform operations and inverse orthogonal transform operations at the time of image encoding and image decoding in the portable telephone device 920 can be reduced.

### 9. Ninth Embodiment

### [Third Example Application: Recording/Reproducing Apparatus]

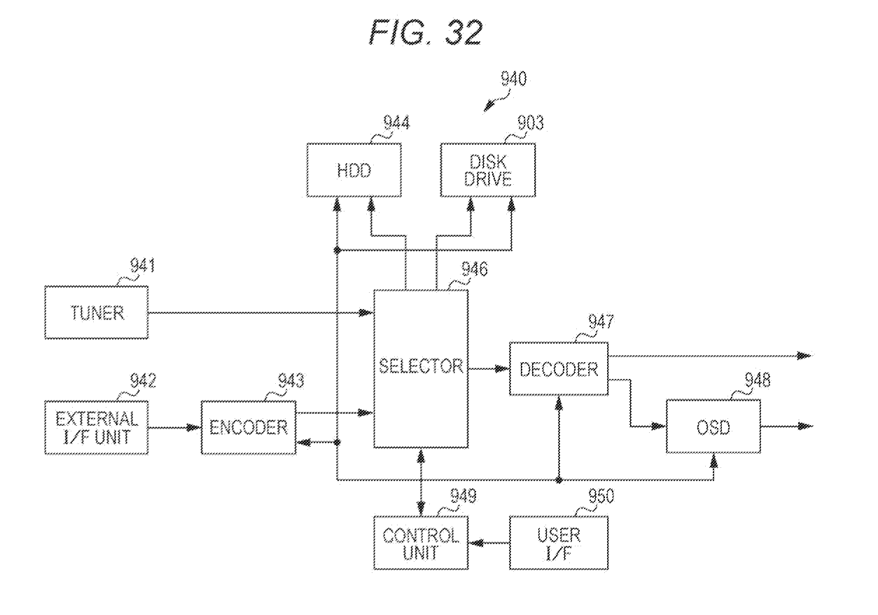

FIG. 32 schematically shows an example structure of a recording/reproducing apparatus to which the above described embodiments are applied. A recording/reproducing apparatus 940 encodes audio data and video data of a received broadcast show, for example, and records the audio data and the video data on a recording medium. The recording/reproducing apparatus 940 may encode audio data and video data acquired from another apparatus, for example, and record the audio data and the video data on the recording medium. The recording/reproducing apparatus 940 also reproduces data recorded on the recording medium through a monitor and a speaker in accordance with an instruction from the user, for example. In doing so, the recording/reproducing apparatus 940 decodes audio data and video data.

The recording/reproducing apparatus 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from broadcast signals received via an antenna (not shown), and demodulates the extracted signal. The tuner 941 outputs the encoded bit stream obtained by the demodulation to the selector 946. That is, the tuner 941 serves as a transmission means in the recording/reproducing apparatus 940.

The external interface 942 is an interface for connecting the recording/reproducing apparatus 940 to an external device or a network. The external interface 942 may be an IEEE1394 interface, a network interface, a USB interface, or a flash memory interface, for example. Video data and audio data received via the external interface 942 are input to the encoder 943, for example. That is, the external interface 942 serves as a transmission means in the recording/reproducing apparatus 940.

In a case where video data and audio data input from the external interface 942 have not been encoded, the encoder 943 encodes the video data and the audio data. The encoder 943 then outputs an encoded bit stream to the selector 946.

The HDD 944 records an encoded bit stream formed by compressing content data such as video images and sound, various programs, and other data on an internal hard disk. At the time of reproduction of video images and sound, the HDD 944 reads those data from the hard disk.

The disk drive 945 records data on and reads data from a recording medium mounted thereon. The recording medium mounted on the disk drive 945 may be a DVD (such as a DVD-Video, a DVD-RAM, a DVD-R, a DVD-RW, a DVD+R, or a DVD+RW) or a Blu-ray (a registered trade name) disc, for example.

At the time of recording of video images and sound, the selector 946 selects an encoded bit stream input from the tuner 941 or the encoder 943, and outputs the selected encoded bit stream to the HDD 944 or the disk drive 945. At the time of reproduction of video images and sound, the selector 946 also outputs an encoded bit stream input from the HDD 944 or the disk drive 945, to the decoder 947.

The decoder 947 decodes the encoded bit stream, and generates video data and audio data. The decoder 947 outputs the generated video data to the OSD 948. The decoder 904 also outputs the generated audio data to an external speaker.

The OSD 948 reproduces the video data input from the decoder 947, and displays video images. The OSD 948 may superimpose an image of a GUI such as a menu and buttons or a cursor on the video images to be displayed.

The control unit 949 includes a processor such as a CPU, and a memory such as a RAM or a ROM. The memory stores the program to be executed by the CPU, program data, and the like. The program stored in the memory is read by the CPU at the time of activation of the recording/reproducing apparatus 940, for example, and is then executed. By executing the program, the CPU controls operations of the recording/reproducing apparatus 940 in accordance with an operating signal input from the user interface 950, for example.

The user interface unit is connected to the control unit 949. The user interface 950 includes buttons and switches for the user to operate the recording/reproducing apparatus 940, and a reception unit for remote control signals, for example. The user interface 950 generates an operating signal by detecting an operation by the user via those components, and outputs the generated operating signal to the control unit 949.

In the recording/reproducing apparatus 940 having the above described structure, the encoder 943 has the functions of the image encoding device according to the above described embodiments. Also, the decoder 947 has the functions of the image decoding device according to the above described embodiments. Accordingly, the size of the transposition registers to be used in orthogonal transform operations and inverse orthogonal transform operations at the time of image encoding and image decoding in the recording/reproducing apparatus 940 can be reduced.

### 10. Tenth Embodiment

### [Fourth Example Application: Imaging Apparatus]

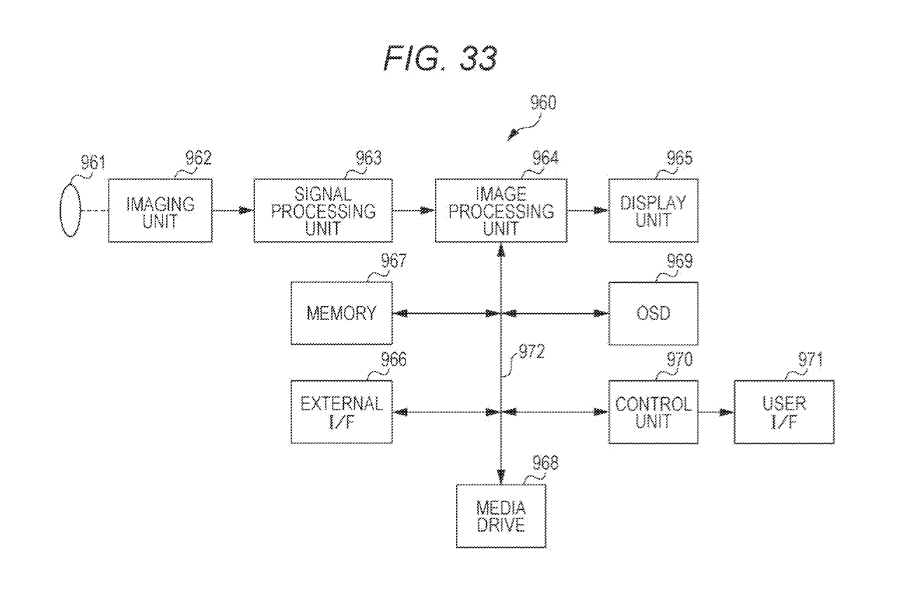

FIG. 33 schematically shows an example structure of an imaging apparatus to which the above described embodiments are applied. An imaging apparatus 960 generates images by imaging an object, encodes the image data, and records the image data on a recording medium.

The imaging apparatus 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the media drive 968, the OSD 969, and the control unit 970 to one another.

The optical block 961 includes a focus lens and a diaphragm. The optical block 961 forms an optical image of an object on the imaging surface of the imaging unit 962. The imaging unit 962 includes an image sensor such as a CCD (Charge Coupled Device) or a CMOS (Complementary Metal Oxide Semiconductor), and converts the optical image formed on the imaging surface into an image signal as an electrical signal by a photoelectric conversion. The imaging unit 962 outputs the image signal to the signal processing unit 963.

The signal processing unit 963 performs various kinds of camera signal processing such as a knee correction, a gamma correction, and a color correction on the image signal input from the imaging unit 962. The signal processing unit 963 outputs the image data subjected to the camera signal processing to the image processing unit 964.

The image processing unit 964 encodes the image data input from the signal processing unit 963, and generates encoded data. The image processing unit 964 outputs the generated encoded data to the external interface 966 or the media drive 968. The image processing unit 964 also decodes encoded data input from the external interface 966 or the media drive 968, and generates image data. The image processing unit 964 outputs the generated image data to the display unit 965. Alternatively, the image processing unit 964 may output the image data input from the signal processing unit 963 to the display unit 965 to display images. The image processing unit 964 may also superimpose display data acquired from the OSD 969 on the images to be output to the display unit 965.

The OSD 969 generates an image of a GUI such as a menu and buttons or a cursor, for example, and outputs the generated image to the image processing unit 964.

The external interface 966 is formed as a USB input/output terminal, for example. The external interface 966 connects the imaging apparatus 960 to a printer at the time of printing of an image, for example. A drive is also connected to the external interface 966, if necessary. A removable medium such as a magnetic disk or an optical disk is mounted on the drive so that a program read from the removable medium can be installed into the imaging apparatus 960. Further, the external interface 966 may be designed as a network interface to be connected to a network such as a LAN or the Internet. That is, the external interface 966 serves as a transmission means in the imaging apparatus 960.

A recording medium to be mounted on the media drive 968 may be a readable/rewritable removable medium such as a magnetic disk, a magnetooptical disk, an optical disk, or a semiconductor memory. Also, a recording medium may be fixed to the media drive 968, to form a non-portable storage unit such as an internal hard disk drive or an SSD (Solid State Drive).

The control unit 970 includes a processor such as a CPU, and a memory such as a RAM or a ROM. The memory stores the program to be executed by the CPU, program data, and the like. The program stored in the memory is read by the CPU at the time of activation of the imaging apparatus 960, for example, and is then executed. By executing the program, the CPU controls operations of the imaging apparatus 960 in accordance with an operating signal input from the user interface 971, for example.

The user interface 971 is connected to the control unit 970. The user interface 971 includes buttons and switches for the user to operate the imaging apparatus 960, for example. The user interface 971 generates an operating signal by detecting an operation by the user via those components, and outputs the generated operating signal to the control unit 970.

In the imaging apparatus 960 having the above described structure, the image processing unit 964 has the functions of the image encoding device and the image decoding device according to the above described embodiments. Accordingly, the size of the transposition registers to be used in orthogonal transform operations and inverse orthogonal transform operations at the time of image encoding and image decoding in the imaging apparatus 960 can be reduced.

In the examples described in this specification, various kinds of information other than image data, such as prediction mode information, are multiplexed with the headers of bit streams, and are transmitted from the encoding side to the decoding side. However, the method of transmitting the information is not limited to the above example. The information may not be multiplexed with an encoded bit stream, but may be transmitted or recorded as independent data associated with an encoded bit stream. Here, the term “associate” means to link an image (or part of an image, such as a slice or a block) included in a bit stream to the information corresponding to the image at the time of decoding. In other words, the information may be transmitted through a different transmission path from images (or bit streams). Also, the information may be recorded on a different recording medium (or a different recording area in the same recording medium) from images (or bit streams). Further, each piece of the information may be associated with frames, one frame, or part of a frame of images (or bit streams).

Although preferred embodiments of this disclosure have been described above with reference to the accompanying drawings, the present invention is not limited to those examples. It should be apparent to those who have ordinary skills in the art can make various changes or modifications within the scope of the technical spirit claimed herein, and it is naturally considered that those changes or modifications are within the technical scope of this disclosure.

The present technique can also be in the following forms.

(1) An image processing device including:

a horizontal one-dimensional inverse transform unit that performs a horizontal inverse orthogonal transform on an orthogonal transform coefficient generated by performing an orthogonal transform on image data in a horizontal direction and a vertical direction;

a bit width processing unit that performs a clip operation on a coefficient to reduce a bit width, the coefficient being obtained by the horizontal one-dimensional inverse transform unit performing the horizontal inverse orthogonal transform;

a storage unit that stores the coefficient as intermediate data, the coefficient having the bit width reduced by the bit width processing unit performing the clip operation; and

a vertical one-dimensional inverse transform unit that reads the intermediate data from the storage unit one line at a time in the vertical direction, and performs a vertical inverse orthogonal transform.

(2) The image processing device of (1), wherein the bit width processing unit performs the clip operation to adjust the coefficient to a bit width in accordance with the frequency band of the coefficient.

(3) The image processing device of (1), further including:

a subtraction unit that subtracts coefficients of the same frequency band from each other, the coefficients being obtained by the horizontal one-dimensional inverse transform unit performing the horizontal inverse orthogonal transform; and

an addition unit that adds the difference value obtained through the subtraction performed by the subtraction unit to one of the coefficients used in the subtraction,

wherein the bit width processing unit performs the clip operation on the difference value obtained through the subtraction, to reduce the bit width of the difference value,

the storage unit stores the intermediate data formed with the one of the coefficients used in the subtraction and the difference value having the bit width reduced by the bit width processing unit,

the addition unit restores the other one of the coefficients used in the subtraction by adding the one of the coefficients used in the subtraction to the difference value having the bit width reduced, the one of the coefficients and the difference value being read from the storage unit, and

the vertical one-dimensional inverse transform unit performs the vertical inverse orthogonal transform on the one of the coefficients used in the subtraction, and the other one of the coefficients used in the subtraction and restored through the addition performed by the addition unit.

(4) The image processing device of (3), wherein

the addition unit reads the intermediate data from the storage unit one line at a time in the vertical direction, and

the storage unit stores the one of the coefficients used in the subtraction in the line to be read by the addition unit at last.

(5) The image processing device of (3) or (4), wherein the bit width processing unit performs the clip operation to adjust the difference value to a predetermined bit width.

(6) The image processing device of (3) or (4), wherein the bit width processing unit performs the clip operation to adjust the difference value to a bit width in accordance with the frequency band of the difference value.

(7) The image processing device of (3), further including a mean value calculation unit that calculates the mean value of coefficients of the same frequency band, the coefficients being obtained by the horizontal one-dimensional inverse transform unit performing the horizontal inverse orthogonal transform,

wherein the subtraction unit calculates a difference value between a coefficient obtained by the horizontal one-dimensional inverse transform unit performing the horizontal inverse orthogonal transform and the mean value calculated by the mean value calculation unit,

the bit width processing unit performs the clip operation on the difference value calculated by the subtraction unit, to reduce the bit width of the difference value,

the storage unit stores the intermediate data formed with the mean value and the difference value having the bit value reduced by the bit width processing unit,

the addition unit restores the coefficient used in the subtraction by adding the difference value to the mean value, the difference value and the mean value being read from the storage unit, and

the vertical one-dimensional inverse transform unit performs the vertical inverse orthogonal transform on the coefficient used in the subtraction.

(8) The image processing device of (7), wherein the bit width processing unit performs the clip operation to adjust the difference value to a predetermined bit width.

(9) The image processing device of (7), wherein the bit width processing unit performs the clip operation to adjust the difference value to a bit width in accordance with the frequency band of the difference value.

(10) The image processing device of any of (1) through (9), wherein the horizontal one-dimensional inverse transform unit and the vertical one-dimensional inverse transform unit perform inverse orthogonal transforms by different transform methods from each other.

(11) An image processing method for an image processing device, including:

a horizontal one-dimensional inverse transform unit performing a horizontal inverse orthogonal transform on an orthogonal transform coefficient generated by performing an orthogonal transform on image data in a horizontal direction and a vertical direction;

a bit width processing unit performing a clip operation on a coefficient to reduce a bit width, the coefficient being obtained through the horizontal inverse orthogonal transform;

a storage unit storing the coefficient as intermediate data, the coefficient having the bit width reduced through the clip operation; and

a vertical one-dimensional inverse transform unit reading the intermediate data from the storage unit one line at a time in the vertical direction, and performing a vertical inverse orthogonal transform.

(12) An image processing device including:

a horizontal one-dimensional transform unit that performs a horizontal orthogonal transform on image data;

a bit width processing unit that performs a clip operation on a coefficient to reduce a bit width, the coefficient being obtained by the horizontal one-dimensional transform unit performing the horizontal orthogonal transform;

a storage unit that stores the coefficient as intermediate data, the coefficient having the bit width reduced by the bit width processing unit performing the clip operation; and

a vertical one-dimensional transform unit that reads the intermediate data from the storage unit one line at a time in the vertical direction, and performs a vertical orthogonal transform.

(13) The image processing device of (12), wherein the bit width processing unit performs the clip operation to adjust the coefficient to a bit width in accordance with the frequency band of the coefficient.

(14) The image processing device of (12), further including:

a subtraction unit that subtracts coefficients of the same frequency band from each other, the coefficients being obtained by the horizontal one-dimensional transform unit performing the horizontal orthogonal transform; and

an addition unit that adds the difference value obtained through the subtraction performed by the subtraction unit to one of the coefficients used in the subtraction,

wherein the bit width processing unit performs the clip operation on the difference value obtained through the subtraction, to reduce the bit width of the difference value,

the storage unit stores the intermediate data formed with the one of the coefficients used in the subtraction and the difference value having the bit width reduced by the bit width processing unit,

the addition unit restores the other one of the coefficients used in the subtraction by adding the one of the coefficients used in the subtraction to the difference value having the bit width reduced, the one of the coefficients and the difference value being read from the storage unit, and

the vertical one-dimensional transform unit performs the vertical orthogonal transform on the one of the coefficients used in the subtraction, and the other one of the coefficients used in the subtraction and restored through the addition performed by the addition unit.

(15) The image processing device of (14), wherein the bit width processing unit performs the clip operation to adjust the difference value to a predetermined bit width.

(16) The image processing device of (14), wherein the bit width processing unit performs the clip operation to adjust the difference value to a bit width in accordance with the frequency band of the difference value.

(17) The image processing device of any of (12) through (16), wherein the horizontal one-dimensional transform unit and the vertical one-dimensional transform unit perform orthogonal transforms by different transform methods from each other.

(18) An image processing method for an image processing device, including:

a horizontal one-dimensional transform unit performing a horizontal orthogonal transform on image data;

a bit width processing unit performing a clip operation on a coefficient to reduce a bit width, the coefficient being obtained through the horizontal orthogonal transform;

a storage unit storing the coefficient as intermediate data, the coefficient having the bit width reduced through the clip operation; and

a vertical one-dimensional transform unit reading the intermediate data from the storage unit one line at a time in the vertical direction, and performing a vertical orthogonal transform.

### REFERENCE SIGNS LIST

100 Image decoding device, 104 Inverse orthogonal transform unit, 131 Horizontal one-dimensional inverse transform unit, 132 Bit width processing unit, 133 Transposition register, 134 Vertical one-dimensional inverse transform unit, 231 Subtraction unit, 232 Addition unit, 331 Mean value calculation unit, 400 Image encoding device, 404 Orthogonal transform unit, 409 Inverse orthogonal transform unit, 431 Horizontal one-dimensional transform unit, 432 Bit width processing unit, 433 Transposition register, 434 Vertical one-dimensional transform unit, 531 Subtraction unit, 532 Addition unit

1. An image processing device comprising:
a horizontal one-dimensional inverse transform unit configured to perform a horizontal inverse orthogonal transform on an orthogonal transform coefficient generated by performing an orthogonal transform on image data in a horizontal direction and a vertical direction;
a bit width processing unit configured to perform a clip operation on a coefficient to reduce a bit width, the coefficient being obtained by the horizontal one-dimensional inverse transform unit performing the horizontal inverse orthogonal transform;
a storage unit configured to store the coefficient as intermediate data, the coefficient having the bit width reduced by the bit width processing unit performing the clip operation; and
a vertical one-dimensional inverse transform unit configured to read the intermediate data from the storage unit one line at a time in the vertical direction, and perform a vertical inverse orthogonal transform.

2. The image processing device according to claim 1, wherein the bit width processing unit performs the clip operation to adjust the coefficient to a bit width in accordance with a frequency band of the coefficient.

3. The image processing device according to claim 1, further comprising:
a subtraction unit configured to subtract coefficients of the same frequency band from each other, the coefficients being obtained by the horizontal one-dimensional inverse transform unit performing the horizontal inverse orthogonal transform; and
an addition unit configured to add a difference value obtained through the subtraction performed by the subtraction unit to one of the coefficients used in the subtraction,
wherein the bit width processing unit performs the clip operation on the difference value obtained through the subtraction, to reduce a bit width of the difference value,
the storage unit stores the intermediate data formed with the one of the coefficients used in the subtraction and the difference value having the bit width reduced by the bit width processing unit,
the addition unit restores the other one of the coefficients used in the subtraction by adding the one of the coefficients used in the subtraction to the difference value having the bit width reduced, the one of the coefficients and the difference value being read from the storage unit, and
the vertical one-dimensional inverse transform unit performs the vertical inverse orthogonal transform on the one of the coefficients used in the subtraction, and the other one of the coefficients used in the subtraction and restored through the addition performed by the addition unit.

4. The image processing device according to claim 3, wherein
the addition unit reads the intermediate data from the storage unit one line at a time in the vertical direction, and
the storage unit stores the one of the coefficients used in the subtraction in a line to be read by the addition unit at last.

5. The image processing device according to claim 3, wherein the bit width processing unit performs the clip operation to adjust the difference value to a predetermined bit width.

6. The image processing device according to claim 3, wherein the bit width processing unit performs the clip operation to adjust the difference value to a bit width in accordance with a frequency band of the difference value.

7. The image processing device according to claim 3, further comprising a mean value calculation unit configured to calculate a mean value of coefficients of the same frequency band, the coefficients being obtained by the horizontal one-dimensional inverse transform unit performing the horizontal inverse orthogonal transform,
wherein the subtraction unit calculates a difference value between a coefficient obtained by the horizontal one-dimensional inverse transform unit performing the horizontal inverse orthogonal transform and the mean value calculated by the mean value calculation unit,
the bit width processing unit performs the clip operation on the difference value calculated by the subtraction unit, to reduce a bit width of the difference value,
the storage unit stores the intermediate data formed with the mean value and the difference value having the bit value reduced by the bit width processing unit,
the addition unit restores the coefficient used in the subtraction by adding the difference value to the mean value, the difference value and the mean value being read from the storage unit, and
the vertical one-dimensional inverse transform unit performs the vertical inverse orthogonal transform on the coefficient used in the subtraction.

8. The image processing device according to claim 7, wherein the bit width processing unit performs the clip operation to adjust the difference value to a predetermined bit width.

9. The image processing device according to claim 7, wherein the bit width processing unit performs the clip operation to adjust the difference value to a bit width in accordance with a frequency band of the difference value.

10. The image processing device according to claim 1, wherein the horizontal one-dimensional inverse transform unit and the vertical one-dimensional inverse transform unit perform inverse orthogonal transforms by different transform methods from each other.

11. An image processing method for an image processing device, the image processing method comprising:
a horizontal one-dimensional inverse transform unit performing a horizontal inverse orthogonal transform on an orthogonal transform coefficient generated by performing an orthogonal transform on image data in a horizontal direction and a vertical direction;
a bit width processing unit performing a clip operation on a coefficient to reduce a bit width, the coefficient being obtained through the horizontal inverse orthogonal transform;
a storage unit storing the coefficient as intermediate data, the coefficient having the bit width reduced through the clip operation; and
a vertical one-dimensional inverse transform unit reading the intermediate data from the storage unit one line at a time in the vertical direction, and performing a vertical inverse orthogonal transform.

12. An image processing device comprising:
a horizontal one-dimensional transform unit configured to perform a horizontal orthogonal transform on image data;
a bit width processing unit configured to perform a clip operation on a coefficient to reduce a bit width, the coefficient being obtained by the horizontal one-dimensional transform unit performing the horizontal orthogonal transform;
a storage unit configured to store the coefficient as intermediate data, the coefficient having the bit width reduced by the bit width processing unit performing the clip operation; and
a vertical one-dimensional transform unit configured to read the intermediate data from the storage unit one line at a time in the vertical direction, and performs a vertical orthogonal transform.

13. The image processing device according to claim 12, wherein the bit width processing unit performs the clip operation to adjust the coefficient to a bit width in accordance with a frequency band of the coefficient.

14. The image processing device according to claim 12, further comprising:
a subtraction unit configured to subtract coefficients of the same frequency band from each other, the coefficients being obtained by the horizontal one-dimensional transform unit performing the horizontal orthogonal transform; and
an addition unit configured to add a difference value obtained through the subtraction performed by the subtraction unit to one of the coefficients used in the subtraction,
wherein the bit width processing unit performs the clip operation on the difference value obtained through the subtraction, to reduce a bit width of the difference value,
the storage unit stores the intermediate data formed with the one of the coefficients used in the subtraction and the difference value having the bit width reduced by the bit width processing unit,
the addition unit restores the other one of the coefficients used in the subtraction by adding the one of the coefficients used in the subtraction to the difference value having the bit width reduced, the one of the coefficients and the difference value being read from the storage unit, and
the vertical one-dimensional transform unit performs the vertical orthogonal transform on the one of the coefficients used in the subtraction, and the other one of the coefficients used in the subtraction and restored through the addition performed by the addition unit.

15. The image processing device according to claim 14, wherein the bit width processing unit performs the clip operation to adjust the difference value to a predetermined bit width.

16. The image processing device according to claim 14, wherein the bit width processing unit performs the clip operation to adjust the difference value to a bit width in accordance with a frequency band of the difference value.

17. The image processing device according to claim 12, wherein the horizontal one-dimensional transform unit and the vertical one-dimensional transform unit perform orthogonal transforms by different transform methods from each other.

18. An image processing method for an image processing device, the image processing method comprising:
a horizontal one-dimensional transform unit performing a horizontal orthogonal transform on image data;
a bit width processing unit performing a clip operation on a coefficient to reduce a bit width, the coefficient being obtained through the horizontal orthogonal transform;
a storage unit storing the coefficient as intermediate data, the coefficient having the bit width reduced through the clip operation; and
a vertical one-dimensional transform unit reading the intermediate data from the storage unit one line at a time in the vertical direction, and performing a vertical orthogonal transform.
